(19) United States
(12) Patent Application Publication
(10) Pub. No.: US 2007/0296107 A1
(43) Pub. Date: Dec. 27, 2007

(54) Casting system and method

(75) Inventor: Yeongchi Wu, Darien, IL (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: PHYSICIANS AGAINST LAND MINES, Chicago, IL (US)

(21) Appl. No.: 11/786,866

(22) Filed: Apr. 13, 2007

Related U.S. Application Data
(60) Provisional application No. 60/792,089, filed on Apr. 13, 2006.

(51) Int. Cl. B29C 33/38

(52) U.S. Cl. 264/102; 425/2

(57) ABSTRACT

A system and method for casting molds that can be used, for example, to make prosthetic or orthodic devices or any other suitable object. The system and method uses an elastic bag containing an elastic, flexible, conformable or resilient material, such as micro polystyrene beads, to cast negative and positive molds of the object using the application of vacuum suction.

This application claims the benefit of U.S. Provisional Application No. 60/792,089, filed Apr. 13, 2006, the entire content being incorporated herein by reference.

### BACKGROUND OF THE INVENTION

1. Field of the Invention

The present invention relates to a system and method for casting molds that can be used, for example, to make prosthetic devices. More particularly, the present invention relates to a system and method for casting negative and positive molds of an object using an elastic bag containing material, such as polystyrene beads or any other suitable type of elastic, flexible, conformable or resilient material.

2. Description of the Related Art

At present, millions of people around the world have various types of disabilities that require the use of orthopedic or prosthetic devices to improve their mobility and overall quality of life. A common type of prosthetic device is an artificial limb.

Various techniques exist to fit an individual with an orthopedic device, such as an artificial arm or leg. For example, plaster bandage can be used to create a negative mold of the limb. The negative mold can be filled with a material, such as plaster, which will take the shape of the limb and thus form a positive mold. The positive mold can then be used to form a prosthetic socket that fits and secures the prosthetic device to the limb.

Another technique, as described in U.S. Pat. No. 6,709,617, employs a dilatancy system, such as that described in U.S. Pat. No. 2,472,754, to create negative and positive molds of the limb to thus create a prosthetic socket. Although this technique may be quite suitable, it is desirable to continue to improve upon systems and methods for forming the various types of molds and prosthetic sockets.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an example of a casting bag according to an embodiment of the present invention, that is used in the casting system and method according to the embodiments of the present invention described herein;

FIG. 2 is a diagram illustrating an example of the elasticity of the casting bag as shown in FIG. 1;

FIG. 3 is a partial view of the casting bag as shown in FIG. 1 having a connector attached thereto;

FIG. 4 is a conceptual diagram illustrating an example of the manner in which the connector of the casting bag as shown in FIG. 3 can be coupled to a vacuum pump;

FIGS. 5-41 illustrate an example of a process for making a transtibial socket using the casting bag as shown in FIG. 1 according to an embodiment of the present invention;

FIGS. 42-54 illustrate an example of a process for making a mold for a transfemoral socket using the casting bag as shown in FIG. 1 according to an embodiment of the present invention;

FIGS. 55-69 illustrate an example of a process for making a mold for a transradial socket using the casting bag as shown in FIG. 1 according to an embodiment of the present invention;

FIGS. 70-86 illustrate an example of a process for making a mold for a transhumeral socket using the casting bag as shown in FIG. 1 according to an embodiment of the present invention;

FIGS. 87-100 illustrate an example of a process for making a mold for a shoe insert using the casting bag as shown in FIG. 1 according to an embodiment of the present invention;

FIGS. 101-113 illustrate an example of a process for making a mold for casting an ankle using the casting bag as shown in FIG. 1 according to an embodiment of the present invention; and

FIGS. 114-124 illustrate an example of a process for making a mold for casting a body jacket using the casting bag as shown in FIG. 1 according to an embodiment of the present invention.

### DETAILED DESCRIPTION OF THE EMBODIMENTS

Embodiments of the present invention will now be described more fully with reference to the accompanying drawings, in which exemplary like reference numerals denote like elements.

As discussed in detail below, the present invention provides a casting system and method that can be used to form molds or impressions of objects, for example, limbs, so that the molds or impressions can be used to fabricate devices, such as prosthetic sockets or orthodic devices. The system and method use a bag containing flexible material, such as lightweight polystyrene beads, for casting the negative mold, which can be converted into a positive model, such as a sand model, for modification and either thermoplastic formation or resin lamination of a socket. Hence, the casting system and method according to the present invention has a dramatically reduced set up cost, and has much lower overall weight and size, compared to conventional casting system. The casting system and method also has increased portability for service in remote areas, and allows the prosthetist more flexibility to manipulate the negative mold on the residual limb for a more precise fitting with the subject. As discussed below, the casting system and method according to the present invention can be utilized for transfemoral, transhumeral, and transradial amputations, shoulder or hip disarticulations, and various other orthoses.

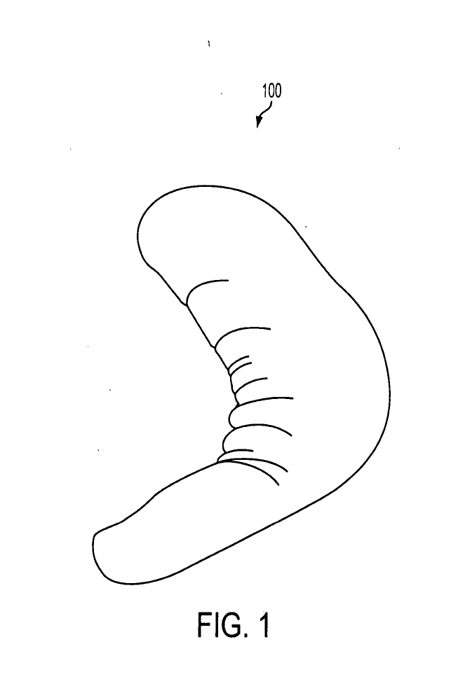

FIG. 1 illustrates an example of casting bag 100 employed in the system and method according to the embodiments of the present invention described herein. As exemplified below, the casting bag 100 with minimal modification in shape and size can be used for all levels of amputation, as well as for casting any type of object. For example, the casting system and method according to the present invention can use the casting bag 100 to fabricate a transtibial prosthesis in an efficient manner (e.g., in less than 60 minutes). The casting bag 100 is made of a flexible, elastic, conformable and/or resilient material, such as a breathable elastic fabric that can include a combination of Spandex and nylon, or any other suitable material, and which is seamless or substantially seamless. The casting bag 100 contains lightweight polystyrene beads or, more particularly, micro-polystyrene beads having a diameter of at or about 1 mm or less, or any other similarly suitable type of synthetic or fabricated bead-like material. The breathable fabric of the casting bag 100 does not allow the beads to pass therethrough even though the fabric will allow air to pass therethrough as discussed in more detail below. In the example show in FIG. 1, the casting bag 100 is a long fabric bag.

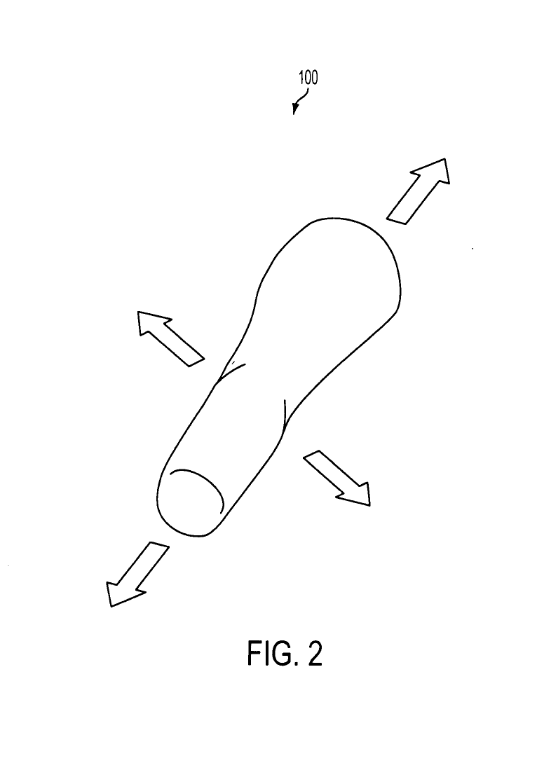

As shown in FIG. 2, the casting bag 100 is stretchable in three-dimensions in the longitudinal and horizontal directions, and can also be twisted, rolled or otherwise manipulated into any suitable shape. The casting bag 100 in this example as has small end and a larger end, and is shaped to form an opening or recess therein in a tube-like manner to receive the object to be cast, such as a limb, as discussed in more detail below. As can be appreciated from the discussion below, the opening or recess is defined by the fabric of the casting bag 100 and does not permit the object to come in contact with the contents (e.g., polystyrene beads) inside the casting bag 100. The casting bag 100 can be configured in various shapes and sizes for casting residual limbs from various levels of amputation and various height of amputees. For example, the sizes of casting bag 100 may range from 12 inches or less to 36 inches long or more, with the flat width of the casting bag 100 ranging from 3 inches or less to 8 inches or more on the smaller end and 6 inches or less to 12 inches or more on the larger end.

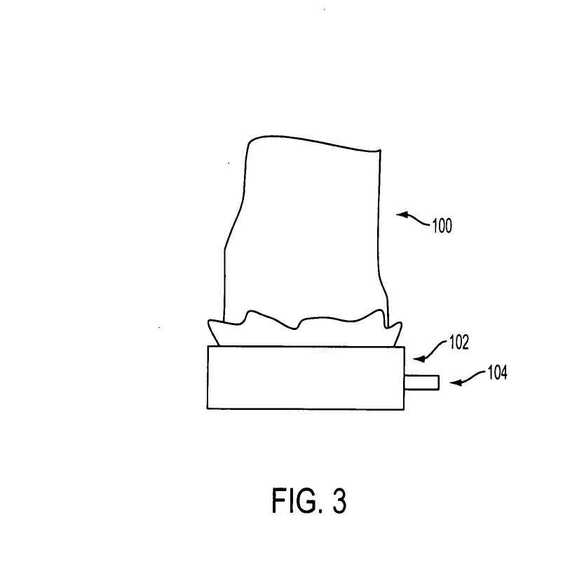

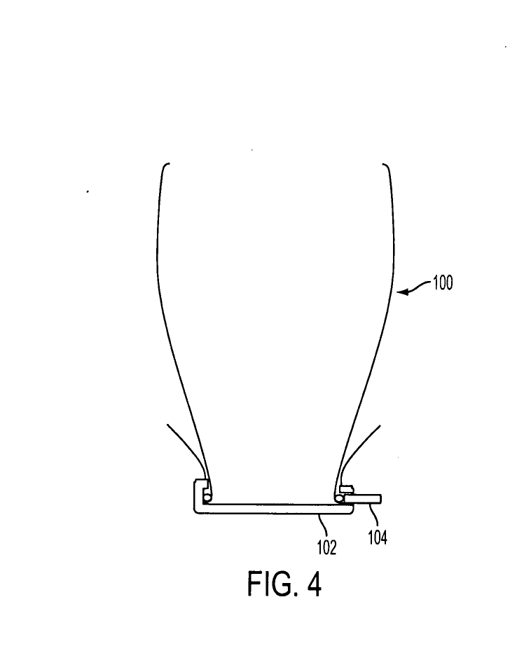

As discussed above, the casting bag 100 is filled with lightweight micro-polystyrene beads. Since the micro-polystyrene beads are compressible and can be expected to reduce in size after long use, the total volume of polystyrene beads in the casting bag may reduce in size, and it may become desirable to refill the casting bag 100 from time to time. As shown in FIG. 3, the casting bag 100 can include a connector 102 that can be removed from the casting bag 102 (e.g., by screwing or in any other suitable manner) to refill the casting bag 100 with beads. The connector 102 further can have a conduit 104 therein to provide access to the interior of the casting bag 100, so that suction can be applied to the casting bag 100. That is, as shown in FIG. 4, the conduit 104 can be coupled to a vacuum pump (not shown) which can provide a negative pressure to the interior of the casting bag 100 for purposes discussed in more detail below. The conduit 104 can include a screen or other barrier that prevents the beads from exiting the conduit 104 when the vacuum is applied.

The following describes different exemplary manners in which the casting bag 100 can be used to create negative and positive molds, that can be used to form a socket for a prosthetic device. Again, the procedures described below can be used to cast other types of objects as desired.

Casting For Transtibial Socket

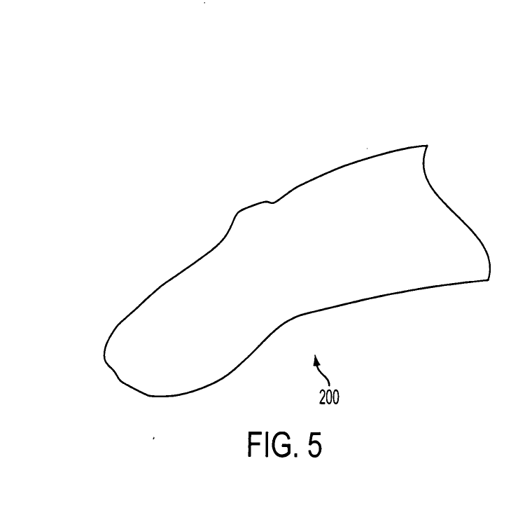

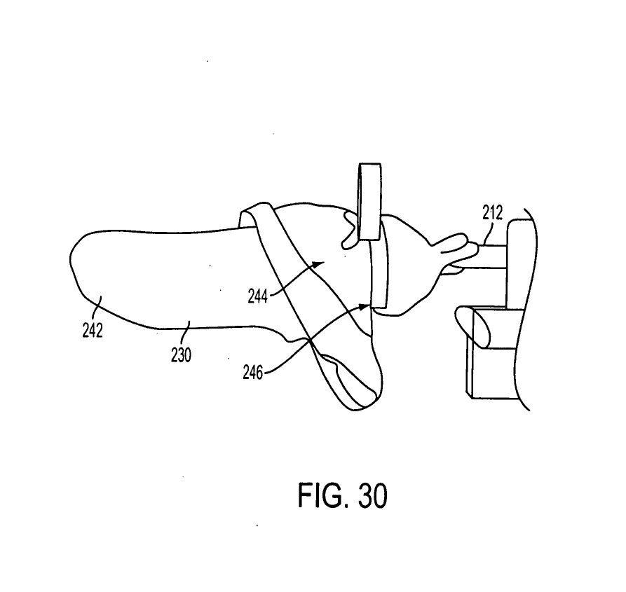

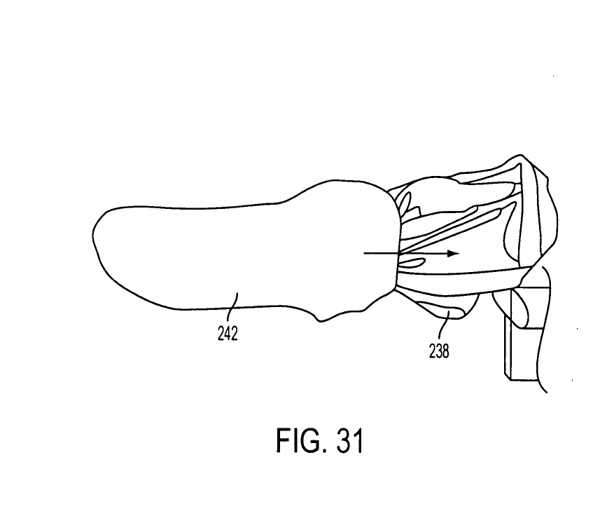

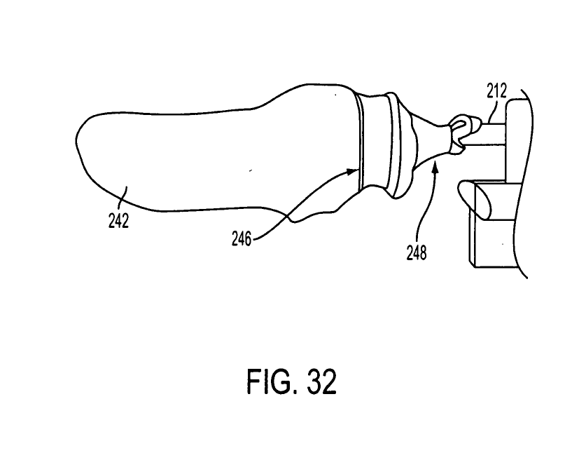

FIGS. 5-41 illustrate an example of a process for making a transtibial socket using the casting bag 100 according to an embodiment of the present invention.

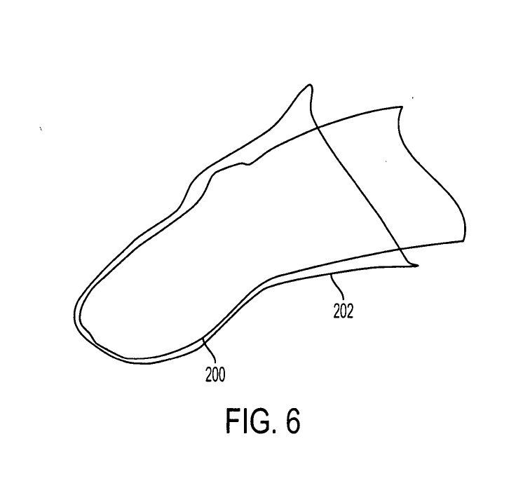

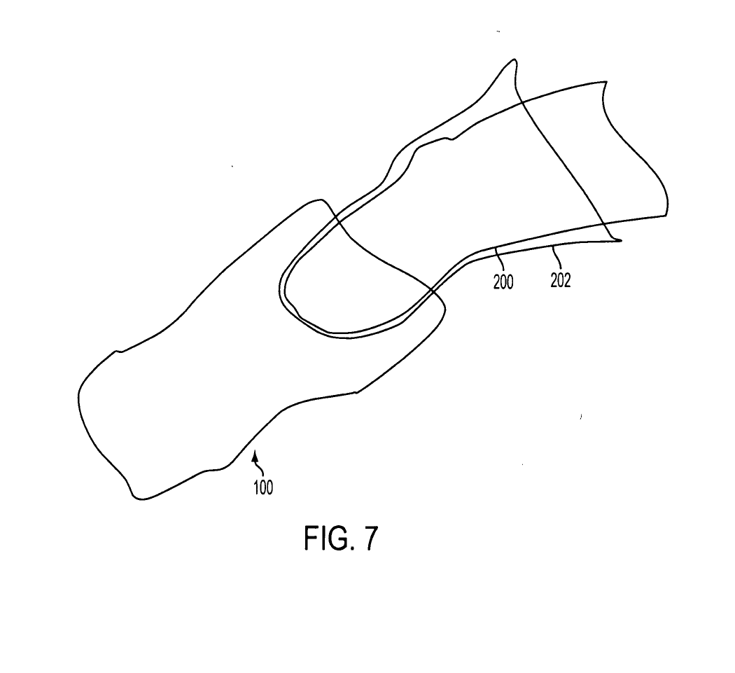

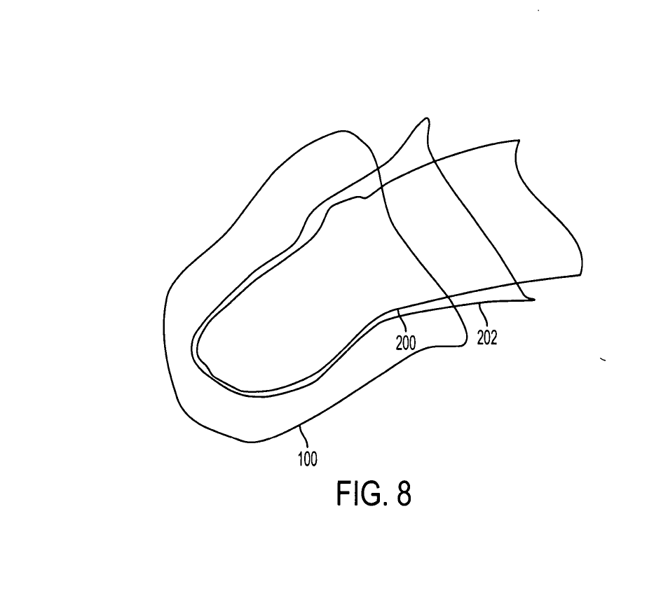

Prior to performing the actual casting process, the prosthetist or other medical personnel can perform a routine patient evaluation and obtain basic measurement of the residual limb 200, which is shown in FIG. 5. As shown in FIG. 6, the residual limb 200 is then covered with a large plastic bag 202. Although the bag 202 in this example is made of plastic, the bag 202 can be made of any suitable conformable, non-porous material that is capable of retaining air. The casting bag 100 can be rolled (e.g., with two hands) evenly over the residual limb 200 and plastic bag 202 as shown in FIG. 7 until the casting bag 100 is slightly above the socket trim line as show in FIG. 8.

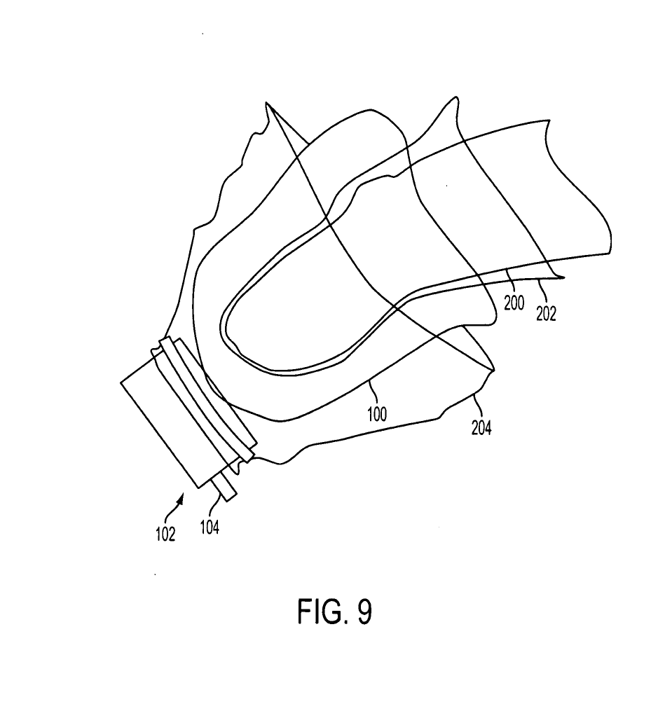

As shown in FIG. 9, the connector 102 is brought with a second plastic bag 204 to the end of the casting bag 100. The connector 102 can simply contact the outer surface of the casting bag 100, which enables conduit 104 to communicate with the interior of the casting bag 100 via the breathable fabric of the casting bag 100. Alternatively, as shown in FIG. 3, the casting bag 100 may already have the connector 102 removably or permanently attached, or can be connected to a coupler (not shown), such as a resealable coupler, that is already attached to the casting bag 100.

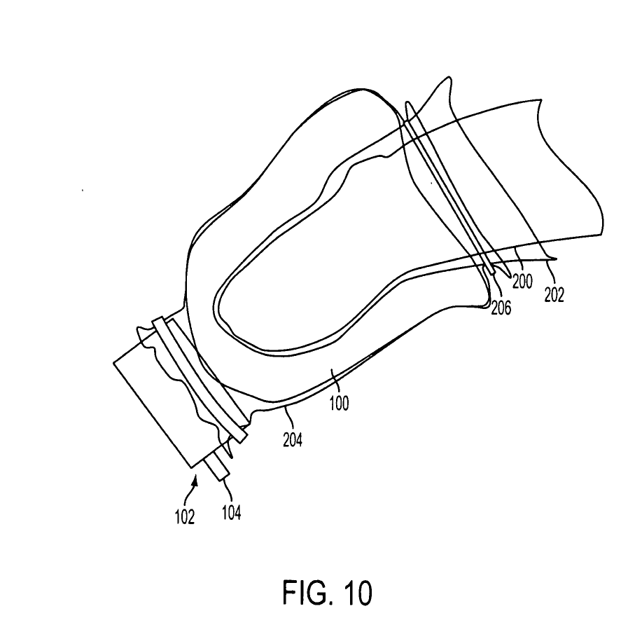

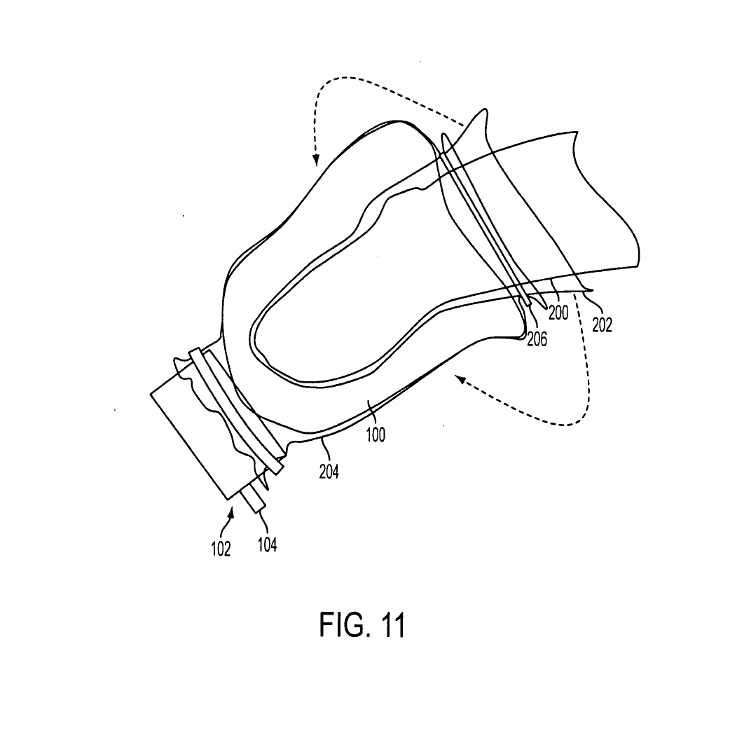

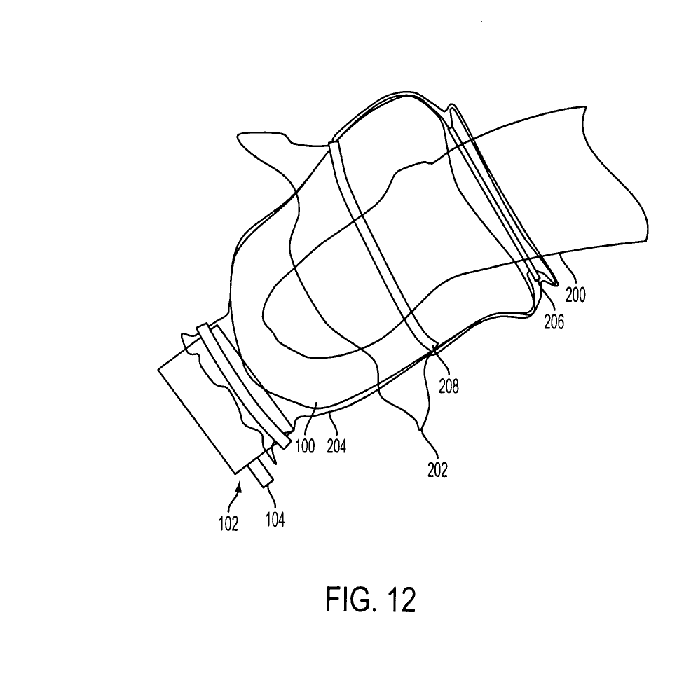

As shown in FIG. 10, a rubber band 206 or other suitable coupling device can be used to hold the second plastic bag 204 down onto the first plastic bag 202. The first plastic bag 202 is then brought down to cover the second plastic bag 204 as shown in FIG. 11. As shown in FIG. 12, a rubber band 208 or other suitable coupling device is then used to seal the first plastic bag 202 onto the second plastic bag 204. At this time, the casting bag 100 becomes enclosed in the first and second plastic bags 202 and 204.

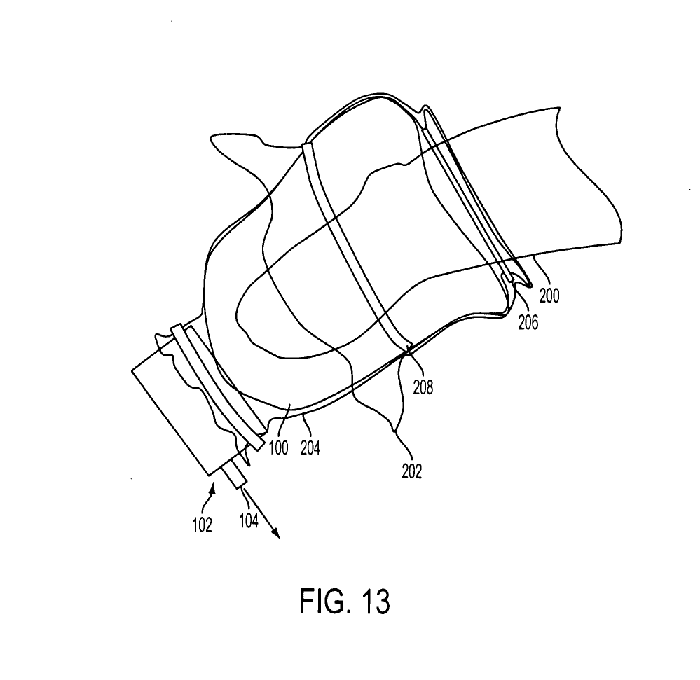

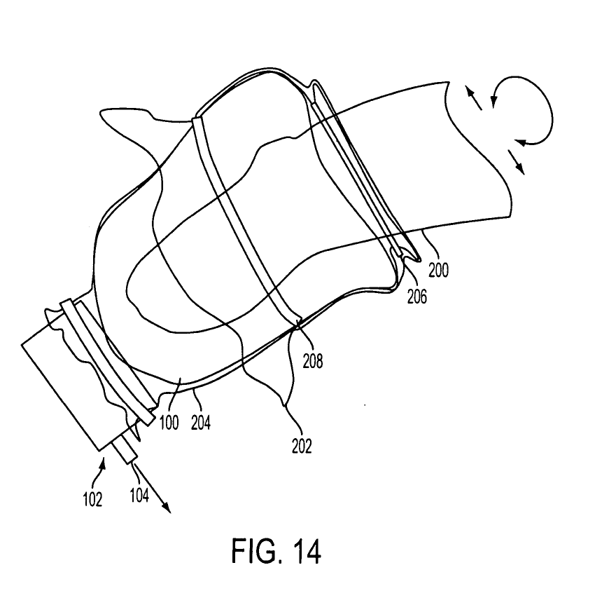

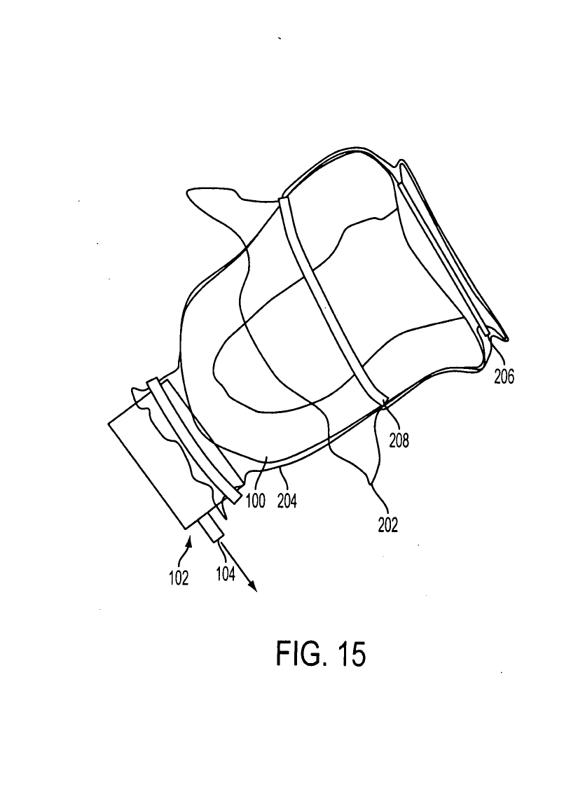

Vacuum suction is then applied through conduit 104 to create a negative pressure in the casting bag 100 to thus solidify the casting bag 100 to form the negative mold of the limb 200 as shown in FIG. 13. The patient can use the negative mold as a check socket to confirm fitting comfort by moving his or her limb 200 as shown in FIG. 14. Once the negative mold is determined properly fit, the residual limb 200 is withdrawn as shown in FIG. 15, and vacuum suction is continued to maintain the negative mold in solid form.

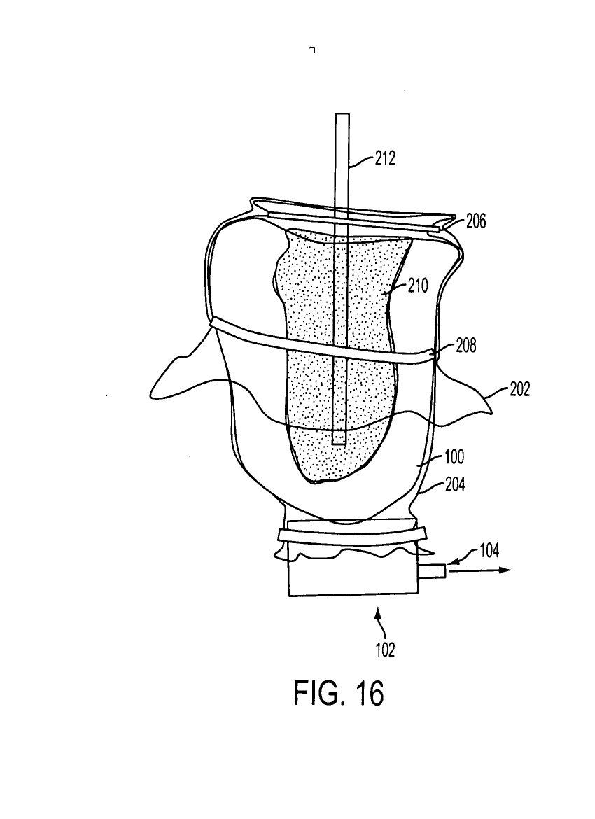

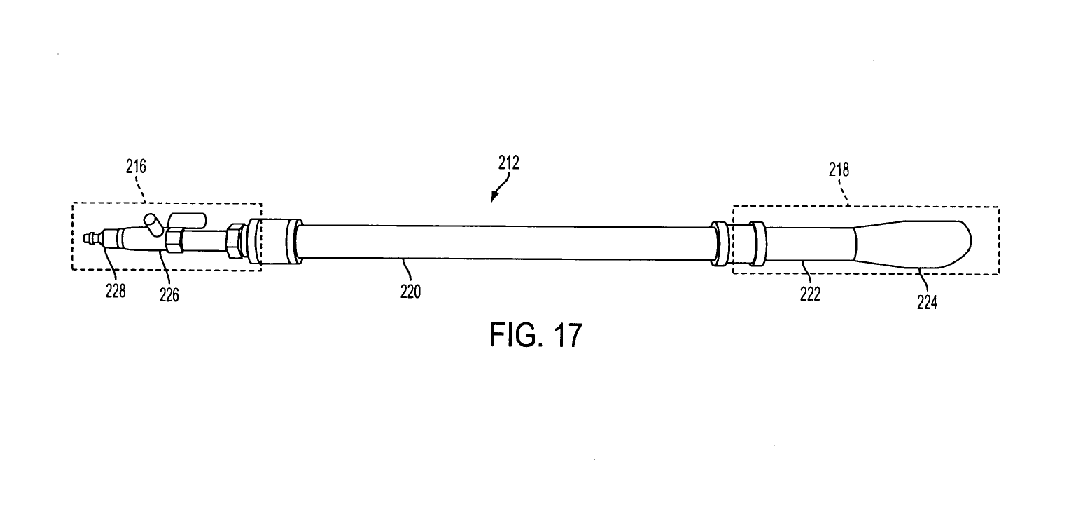

As shown in FIG. 16, the negative mold is then converted into a positive sand model by filling the void of the negative mold with sand 210 to its brim and inserting a vacuum mandrel 212 into the sand 210 (e.g., into the center or substantially the center of the sand 210). As shown in FIG. 17, the mandrel 212 in this example includes a head portion 216 and a tail portion 218. The mandrel 212 can have, for example, a pipe 220 made of steel or any other suitable material, which has an inside diameter of 12 mm or about 12 mm and is 30 cm or about 30 cm long. The tail portion 218 includes a hollow pipe 222 that can be made of steel or any other suitable material, and which is connected to and in communication with the pipe 220. The tail portion 218 further includes a sand filter 224 that allows gas and liquid (e.g., air and water) to pass therethrough without or substantially without allowing sand to enter the pipe 222. The head portion 216 includes an air valve 226 for controlling the flow of air (gas) through the mandrel 212 and an air hose connector 228 that connects to a vacuum pump (e.g., vacuum pump shown in FIG. 4). Further details of the mandrel 212, and variations thereof, can be found in U.S. Pat. No. 6,709,617 to Wu, which is incorporated by reference in its entirety.

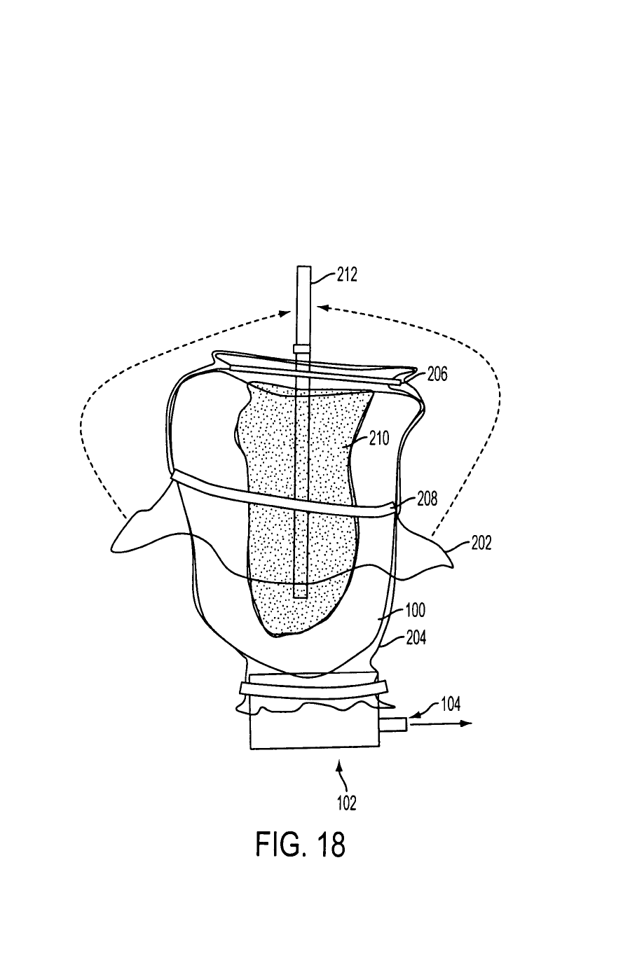

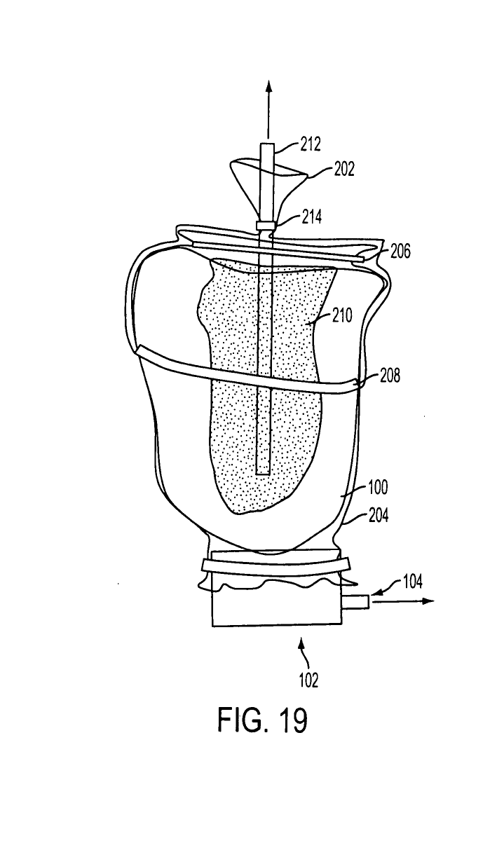

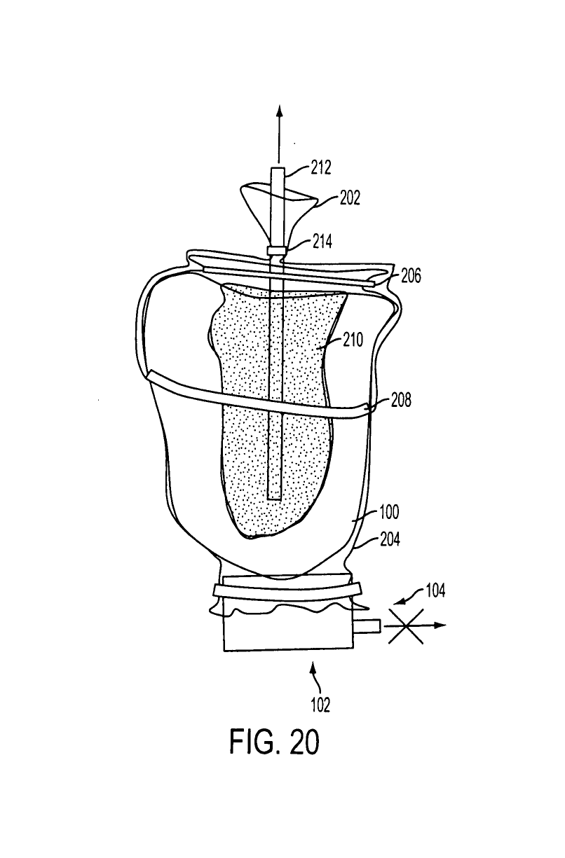

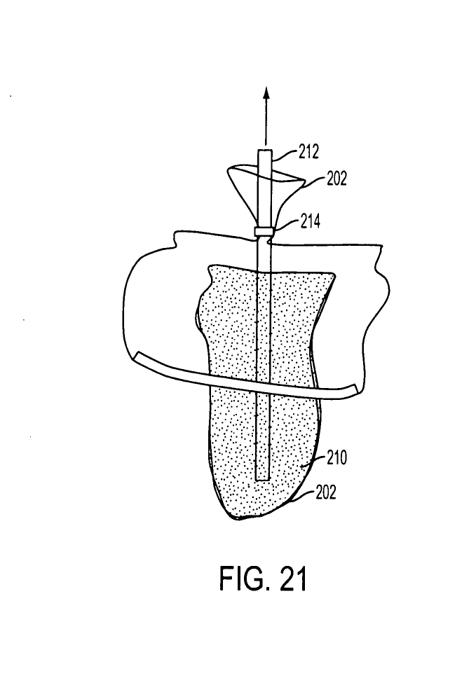

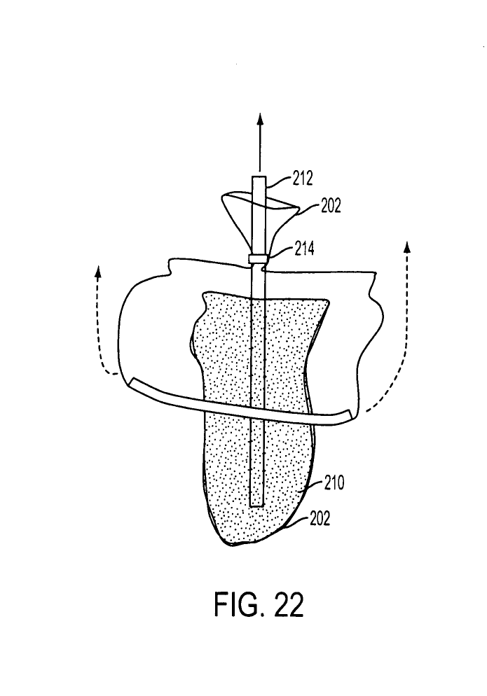

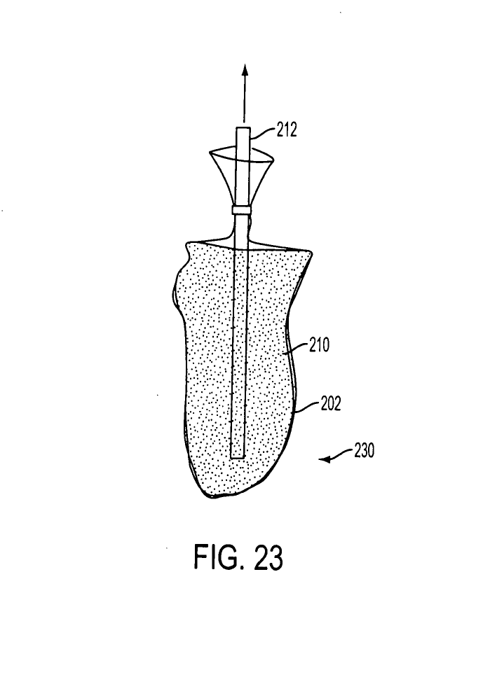

Once the mandrel 212 has been inserted into the sand 210, the first plastic bag 202 is brought upward as shown in FIG. 18. As shown in FIG. 19, the first plastic bag 202 is sealed onto the mandrel 212 with electric tape 214 or any other suitable coupler, and vacuum suction is applied via the mandrel 212 to solidify the positive sand model 210. The vacuum is then disconnected from the casting bag 100 as shown in FIG. 20 in order to loosen the negative mold. Once the casting bag 100 is loose, the casting bag 100 and second bag 204 pulled off of the positive sand model as shown in FIG. 21. The excessive part of the first plastic bag 202 is then pulled upward as shown in FIG. 22, and as shown in FIG. 23, the positive sand model 230 is ready for modification and vacuum forming the transtibial socket.

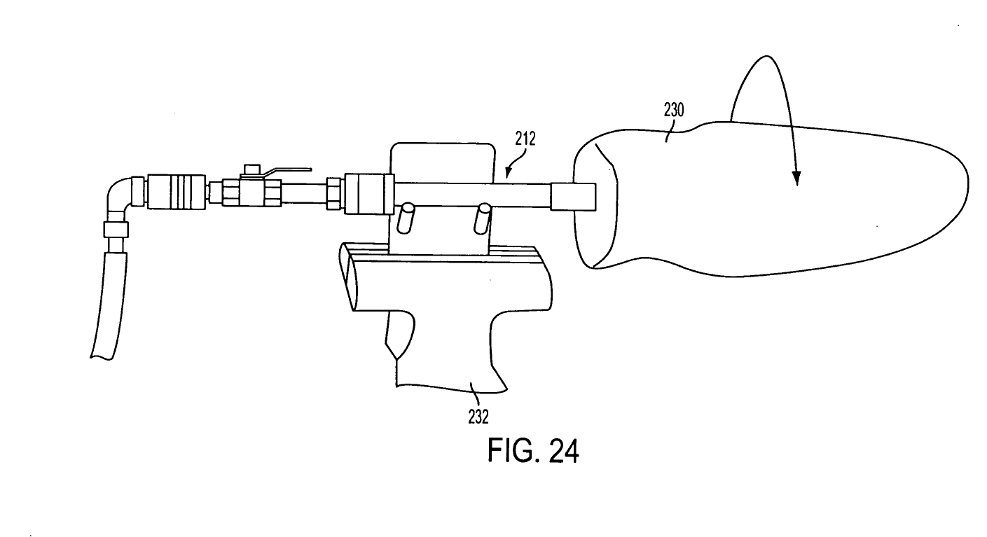

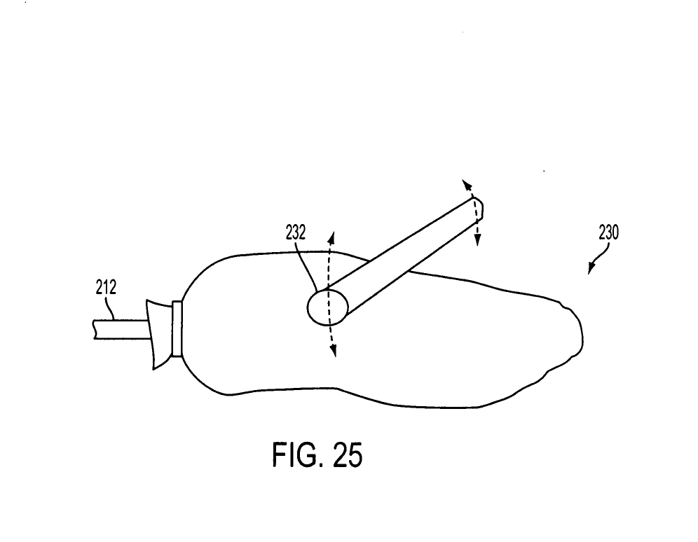

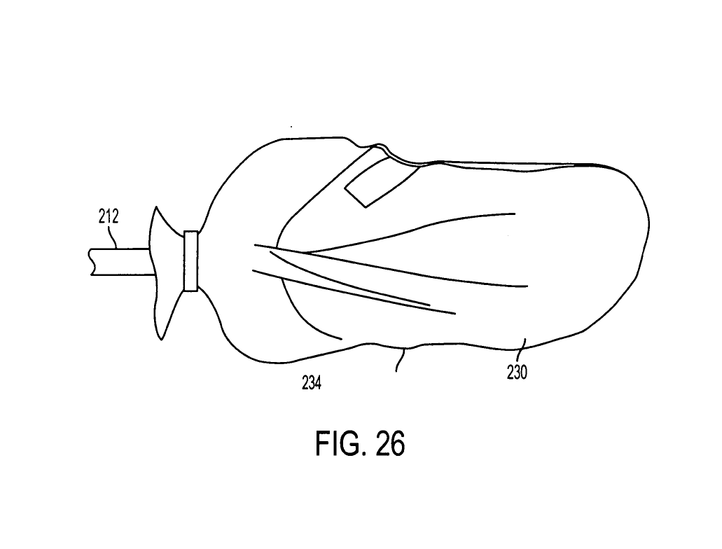

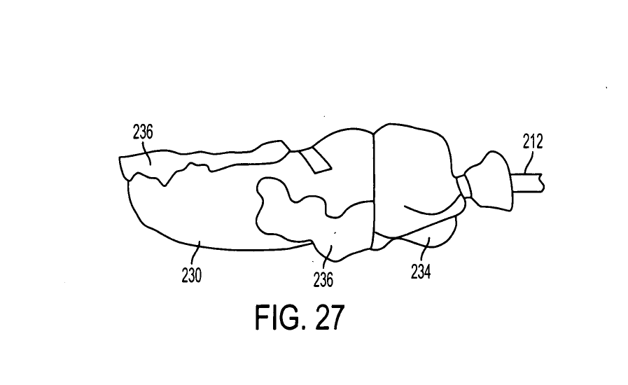

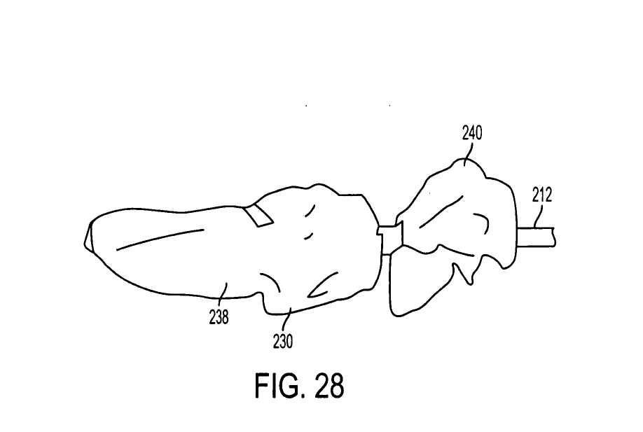

Example of processes for forming the transtibial socket are illustrated in FIGS. 24-41. As shown in FIG. 24, the mandrel 212 having the positive sand model 230 still attached can be placed in a vise 232 which allows the positive sand model 230 to be rotated during modification. That is, as shown in FIG. 25, a bar 232 can be used to modify the surface of the positive sand model 230. Another bag 234 can be placed over the bag 202 if desired as shown in FIG. 26. Clay build ups 236 can be applied to the positive sand model 230 as shown in FIG. 27, and as shown in FIG. 28, another plastic bag 238 can be placed over the positive sand model 230, the clay build-ups and a plastic cup at the top of the positive sand model 230 near the mandrel 212. As many plastic bags as necessary can be placed over the positive sand model 230 if holes keep developing the underlying bags, and then connected with tape 240 or any other suitable connector to the mandrel 212 to maintain the vacuum in the positive sand model 230.

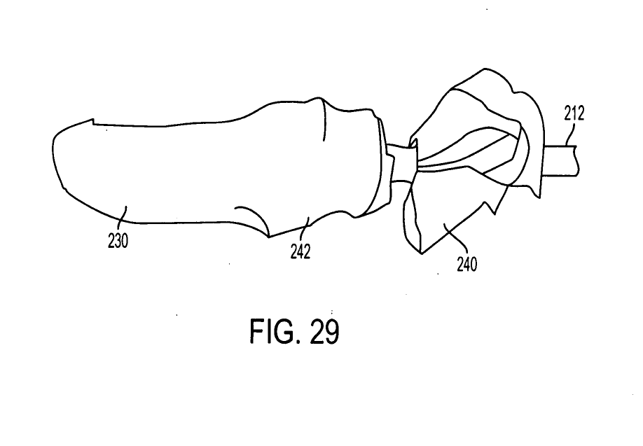

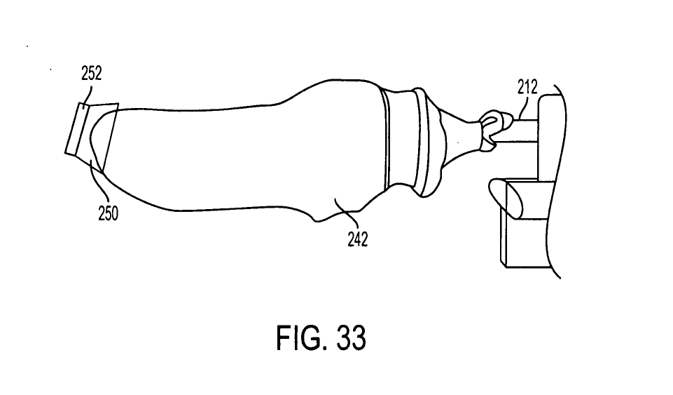

Then, as shown in FIGS. 29-32, a stocking 242 made of nylon or other suitable material can be placed over the positive sand model 230 and the remainder of the top plastic bag 238 can be pulled down and coupled with electrical tape 246 and 248 or any other suitable coupling device to the area of the positive sand model 230 over the plastic cup and to the mandrel 212. Additional clay buildup 250 and an adapter can be added to the positive sand model 230 as shown in FIG. 33 in order for the socket to be able to attach to the prosthesis as can be appreciated by one skilled in the art.

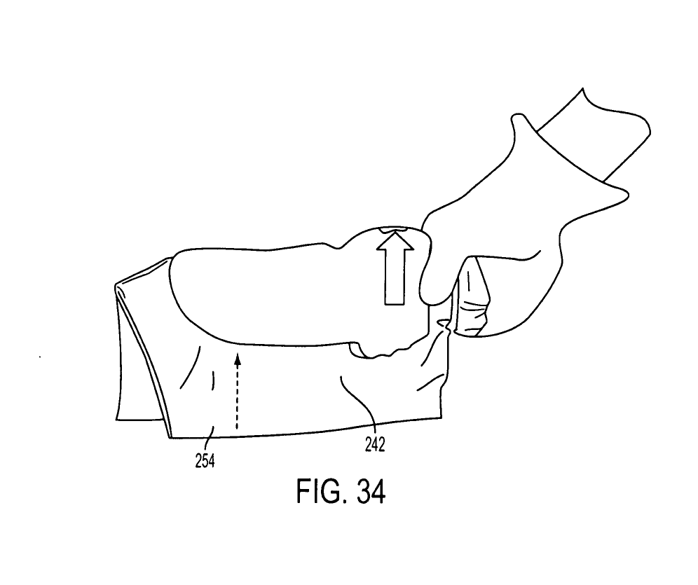

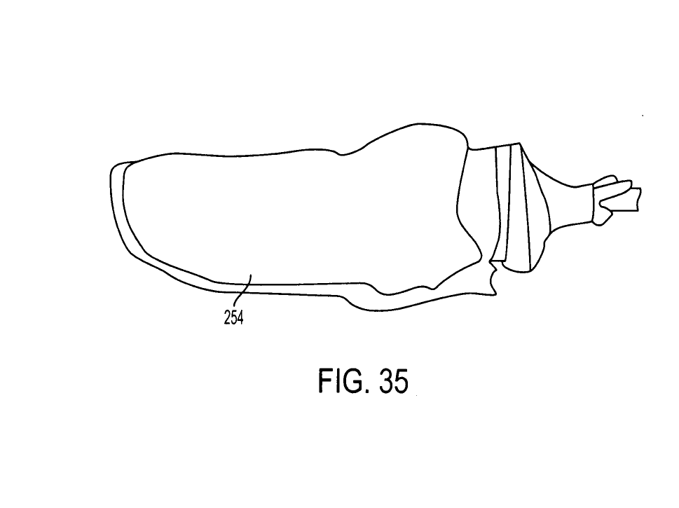

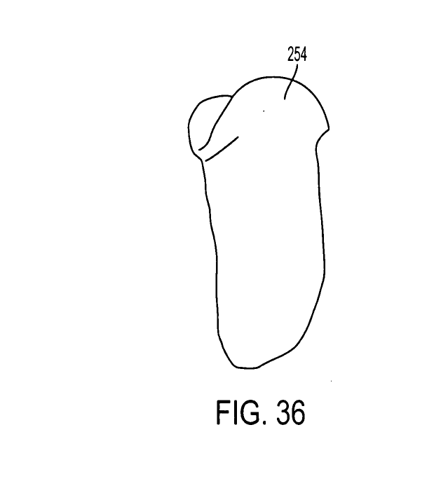

As shown in FIGS. 34 and 35, a malleable material, such as a heated plastic or copolymer material, can then be draped over the positive sand model 230 and shaped to form the socket 254 when the heated plastic cools. The sand can then be let out of the positive sand model 230 by, for example, cutting a large hole in the bag 202 and draining the sand out of the hole, and the formed socket 254 as shown in FIG. 36 can then be removed.

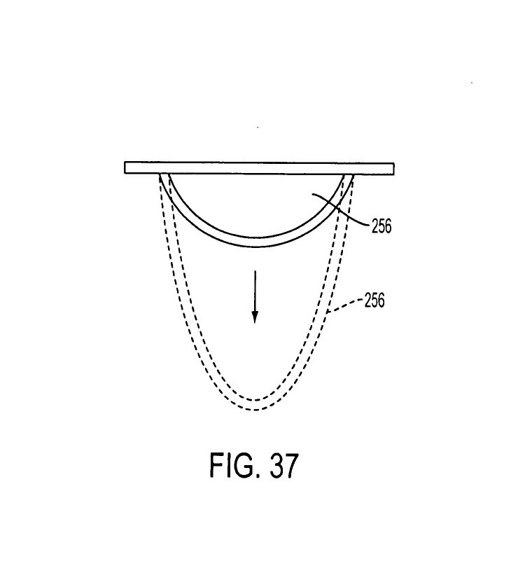

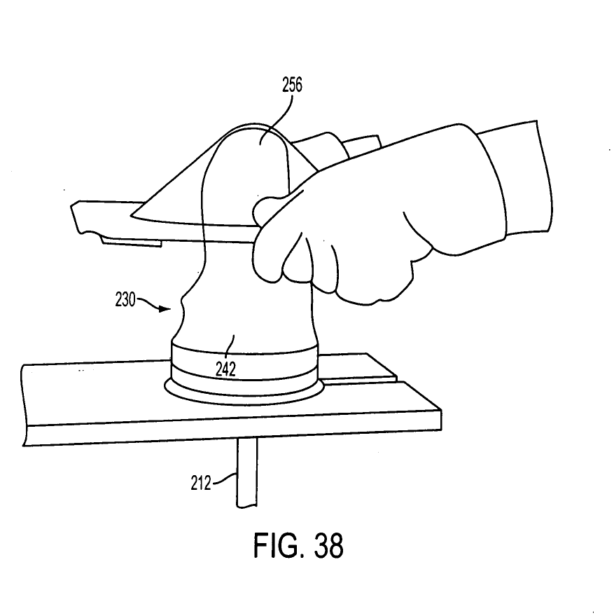

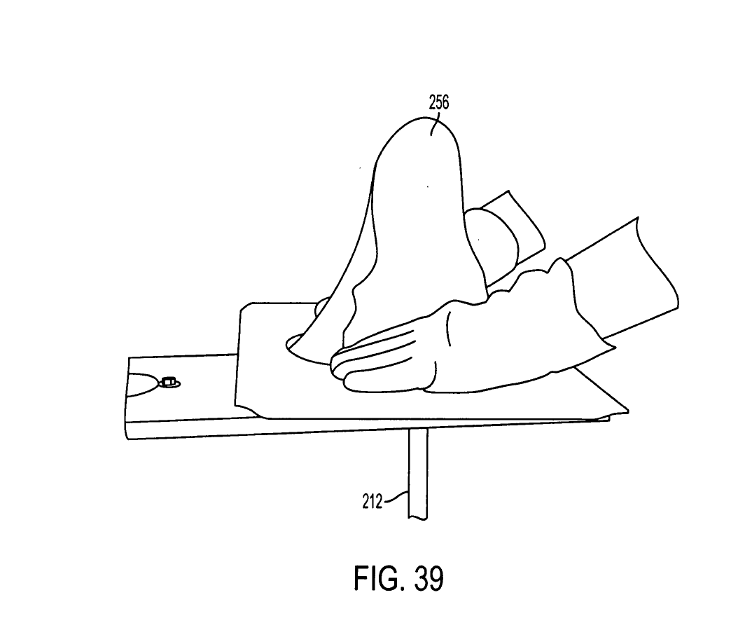

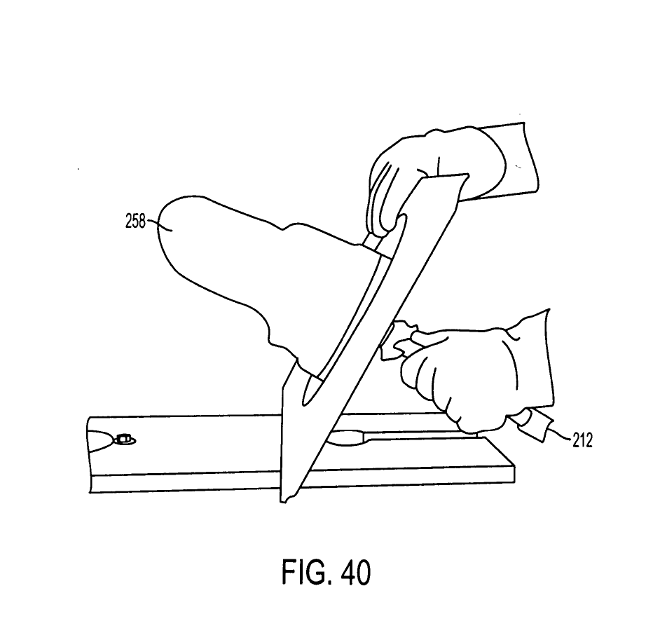

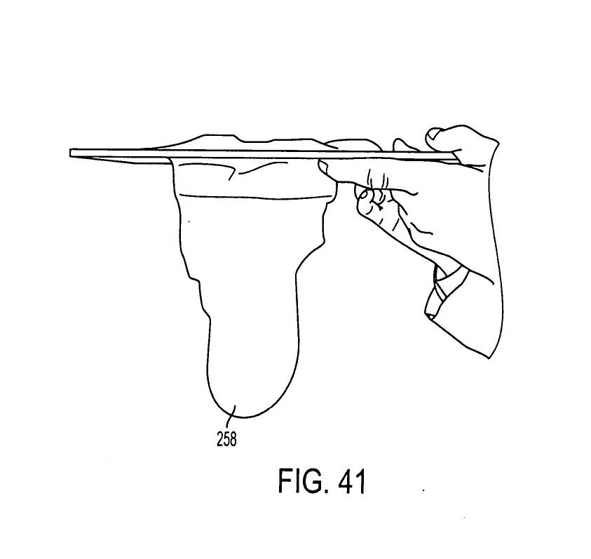

Instead of draping the malleable material over the positive sand model 230 as discussed above, a sagging plastic bubble mold 256 as shown in FIG. 37 can be brought down upon the positive sand model 230 as shown in FIGS. 38 and 39. The sand and mandrel 212 are then removed as shown in FIG. 40, and thus the socket 258 has been formed as shown in FIGS. 40 and 41. Further details and specifics relating to examples of forming the socket are found in U.S. Pat. No. 6,709,617 to Wu, referenced above.

Casting For Transfemoral Socket

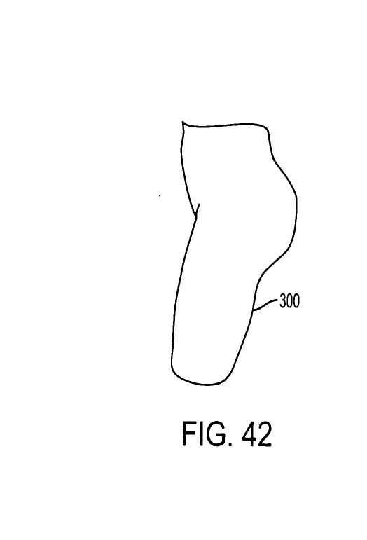

FIGS. 42-54 illustrate an example of a process for making a mold for a transfemoral socket using the casting bag 100 according to an embodiment of the present invention.

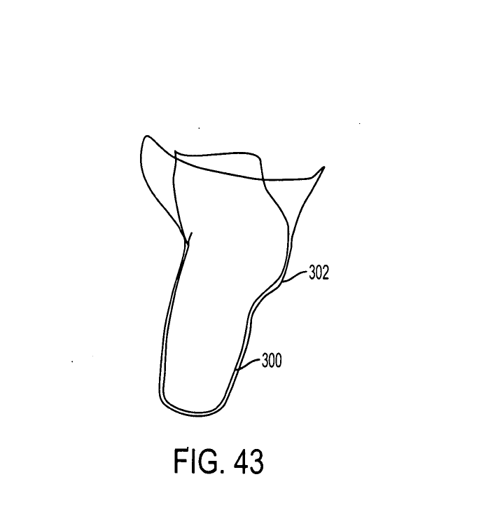

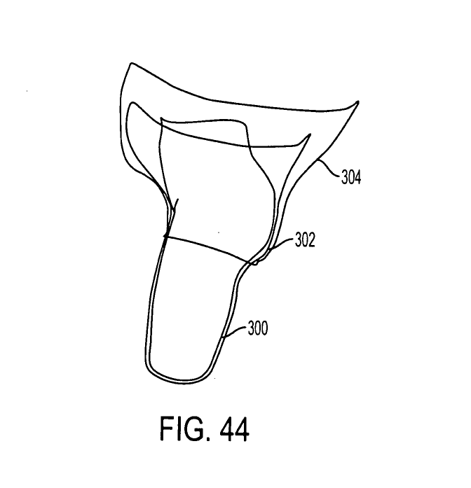

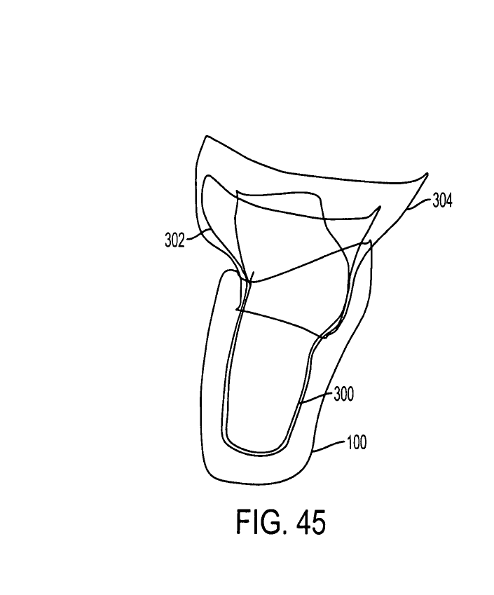

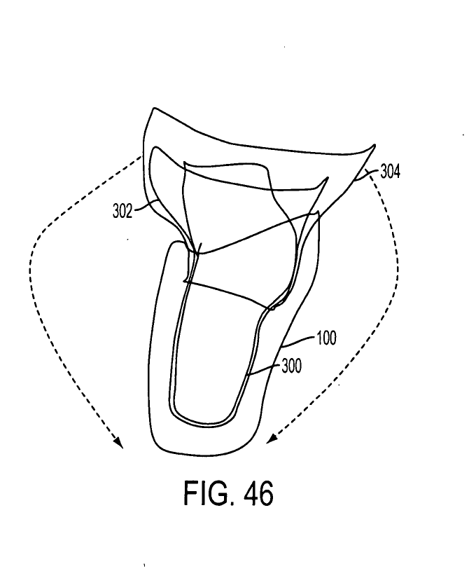

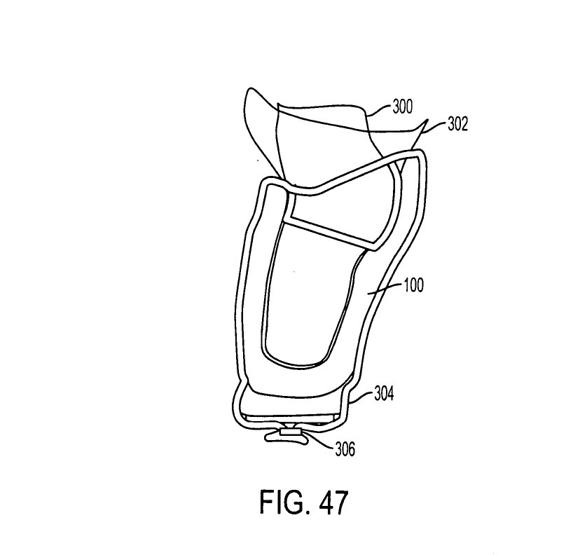

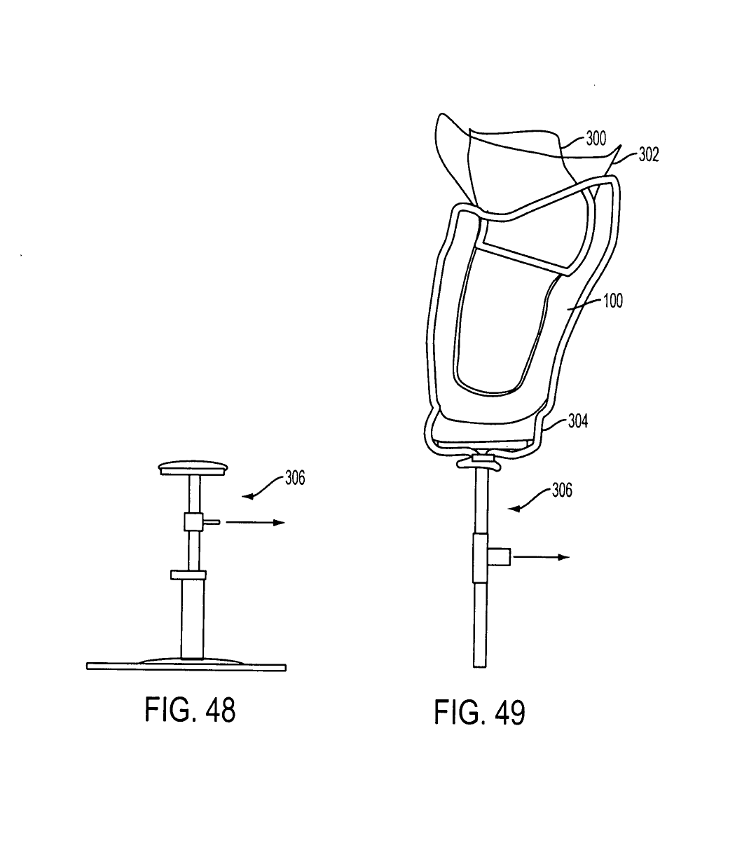

As shown in FIG. 42, a routine patient evaluation is performed and basic measurement of the residual limb 300 are obtained. A first thin large bag 302, made of plastic or any other suitable material as bag 202 discussed above, is applied from the end of the residual limb 300 to the groin and waist areas, as shown in FIG. 43. As shown in FIG. 44, a second thick bag 304, that can be made of plastic or any other suitable material as bag 204 discussed above, is applied from the groin to the waist areas, and the lower end of the second plastic bag 304 has a hole in it of sufficient size to allow the limb 300 and bag 302 to pass through when the second plastic bag 304 is placed over the limb 300. The second plastic bag 304 is tightly sealed over the first plastic bag 302. The casting bag 100 is then rolled over the residual limb 300 slightly above the intended socket trim line as shown in FIG. 45. The excessive part of the second plastic 304 bag is folded downward as shown in FIG. 46, and as shown in FIG. 47, the second plastic bag 304 is sealed to the adjustable pylon 306 shown in FIG. 48, which is adjusted to the proper height to contact the casting bag 100. The pylon 306 is coupled to a vacuum, and applies vacuum suction slowly to control the compression of the casting bag 100 over the residual limb 300 as shown in FIG. 49. The formed negative mold is used as a check socket by the patient to determine the fitting comfort.

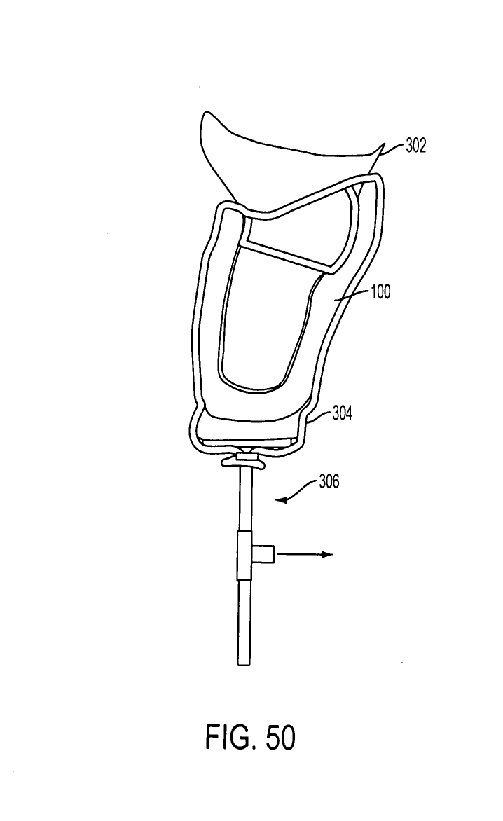

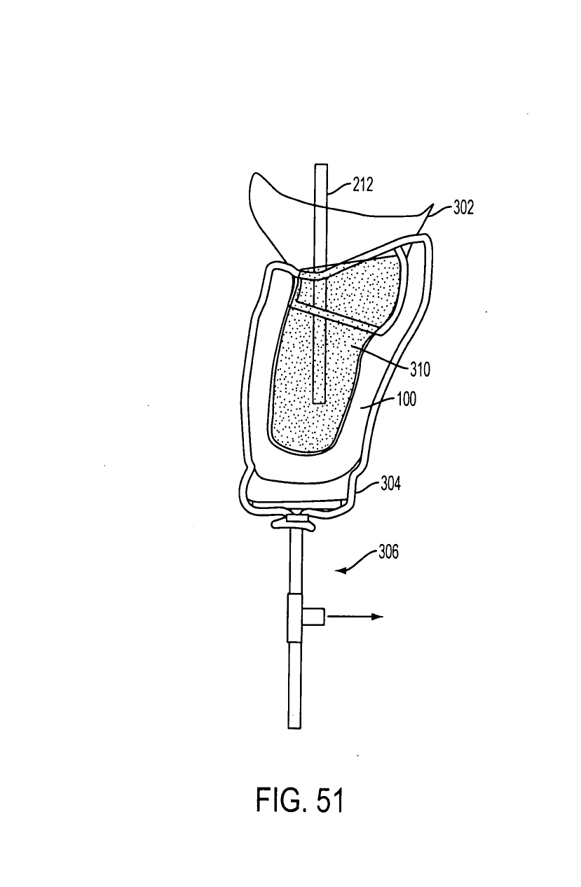

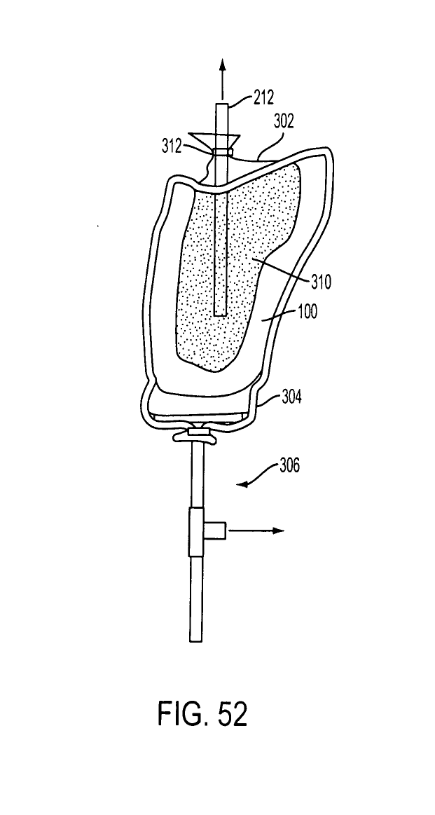

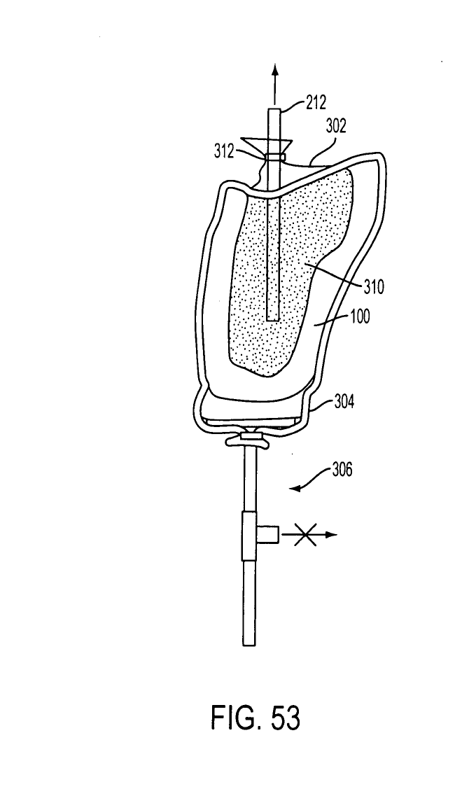

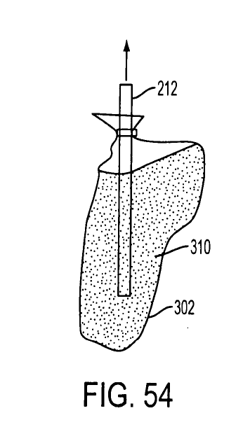

Once the negative mold is determined comfortable, the residual limb 300 is withdrawn as shown in FIG. 50. The inner surface of the negative mold is checked, and any wrinkles can be smoothed away from the first plastic bag 302. As shown in FIG. 51, the negative mold is converted into a positive sand mold by adding sand 310 into the void of the negative mold and inserting the mandrel 212 into the sand 310. The first plastic bag 302 is sealed to the mandrel 212 and vacuum suction is applied to solidify the positive sand model as shown in FIG. 52. The vacuum suction is applied to the positive sand model to form a positive solid sand model 310, then the vacuum is disconnected from the casting bag 100 so that the casting bag 100 and second plastic bag 304 can be removed as shown in FIGS. 53 and 54. The positive sand model 310 is then transferred under vacuum applied via mandrel 212 to the vise 232 as shown in FIG. 24 for modification and vacuum forming the socket in a manner consistent with that described above with regard to FIGS. 24-41 and as discussed further in U.S. Pat. No. 6,709,617 to Wu, referenced above.

Casting For Transradial Socket

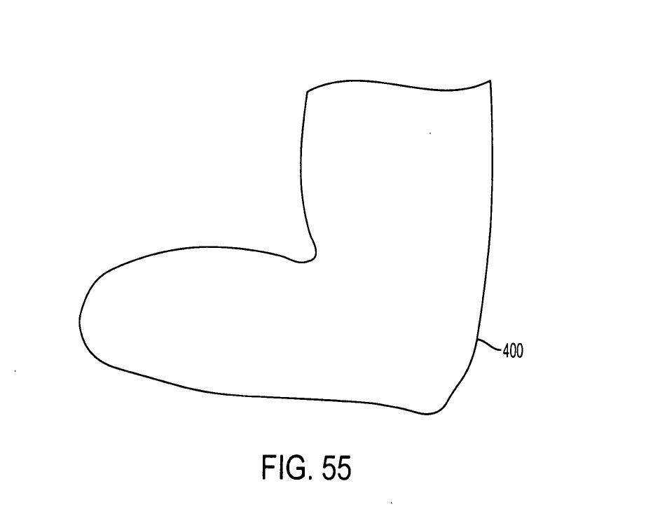

FIGS. 55-69 illustrate an example of a process for making a mold for a transradial socket using the casting bag 100 according to an embodiment of the present invention.

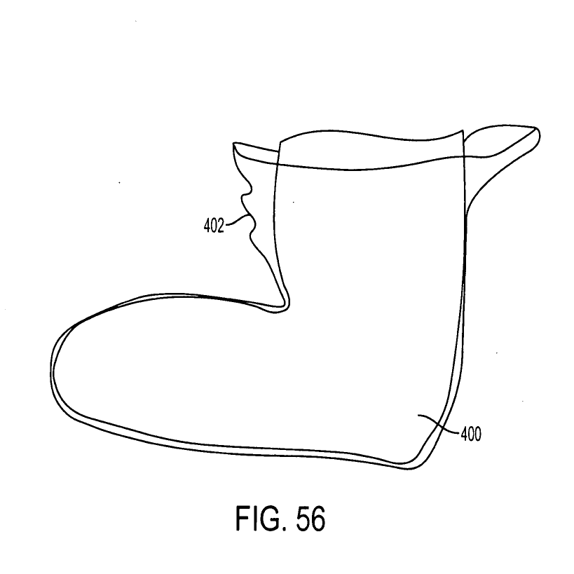

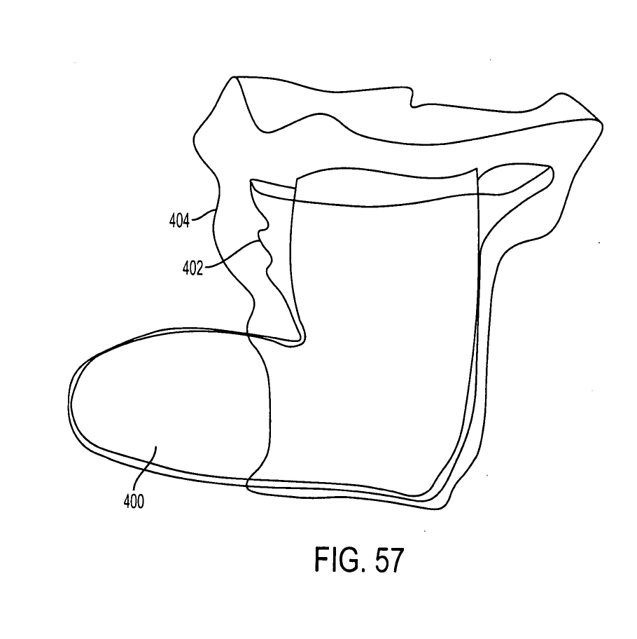

As with the processes described above, a routine patient evaluation is performed and a basic measurement of the residual limb 400 is obtained as shown in FIG. 55. A first bag 402 made of plastic or any other suitable material as discussed above, is then applied over the residual limb 400 up to the mid-arm as shown in FIG. 56, and a second bag 404 made of plastic or any other suitable material is applied from below elbow to high mid-arm as shown in FIG. 57. The second bag 404 has at its lower end an opening therein of sufficient size to allow the limb 400 and first bag 402 to pass therethrough when the second bag 404 is placed over the limb 400 and the first bag.

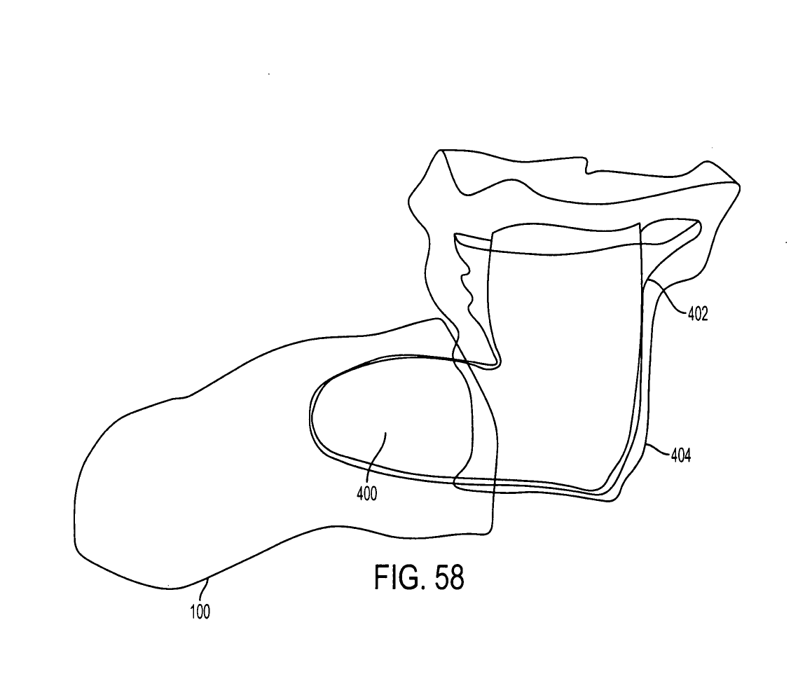

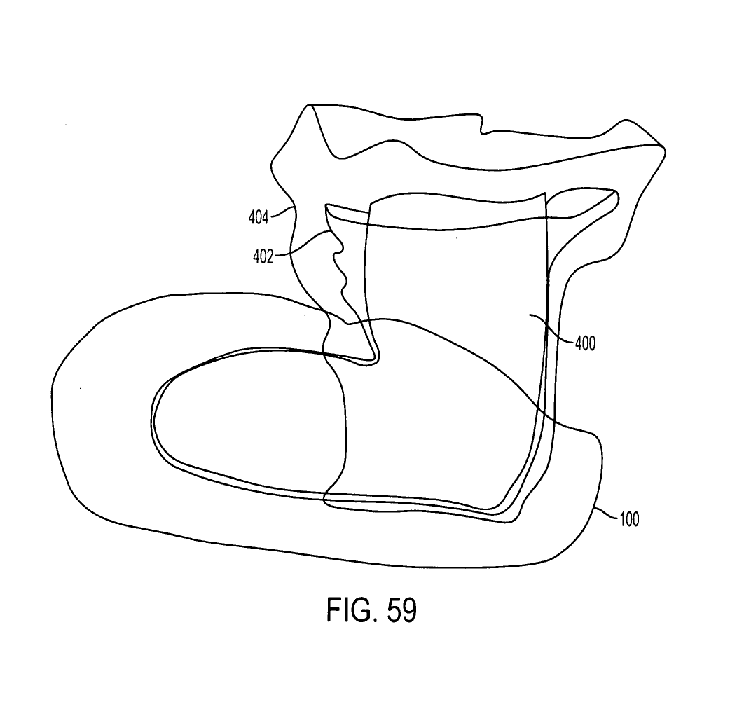

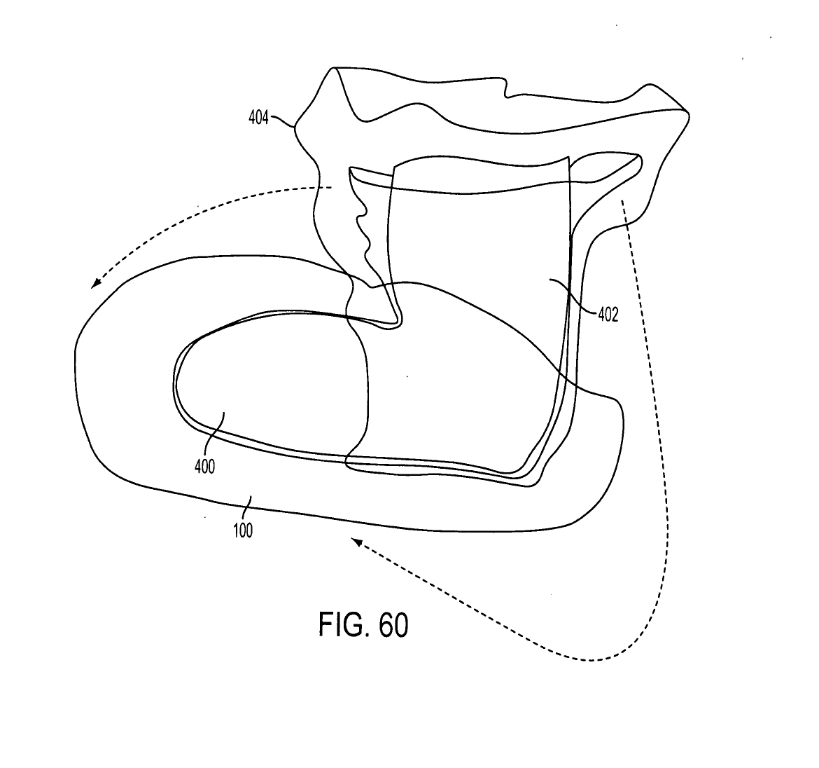

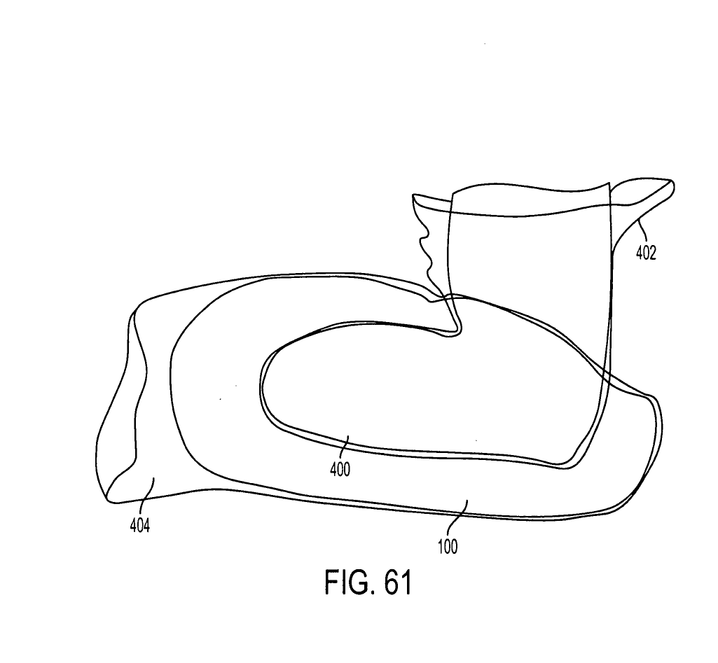

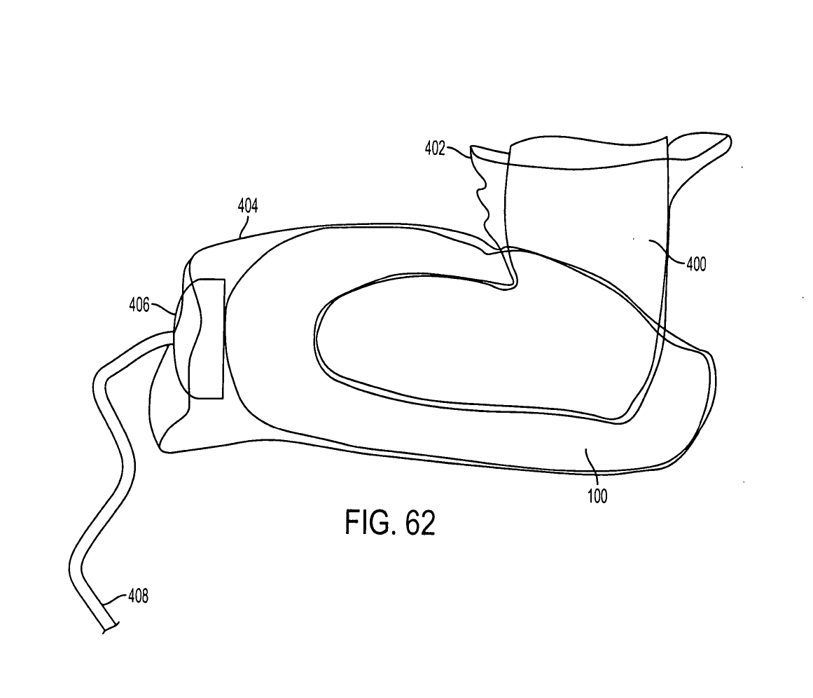

The casting bag 100 can then be rolled evenly over the residual limb 400 as shown in FIG. 58, and moved slightly above the socket trim line as shown in FIG. 59. The second plastic bag 404 is then folded downward as shown in FIG. 60, so that the second plastic bag 404 covers the entire casting bag 100 as shown in FIG. 61.

A connector 406 attached to an air hose 408 is then placed at the end of casting bag as shown in FIG. 62. Alternatively, a connector 102 (FIG. 3) can be used.

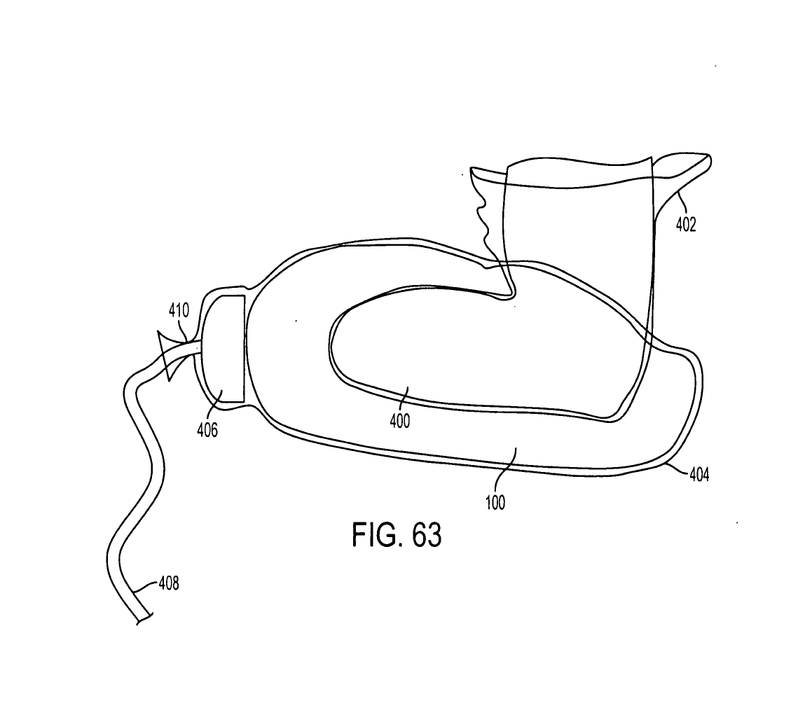

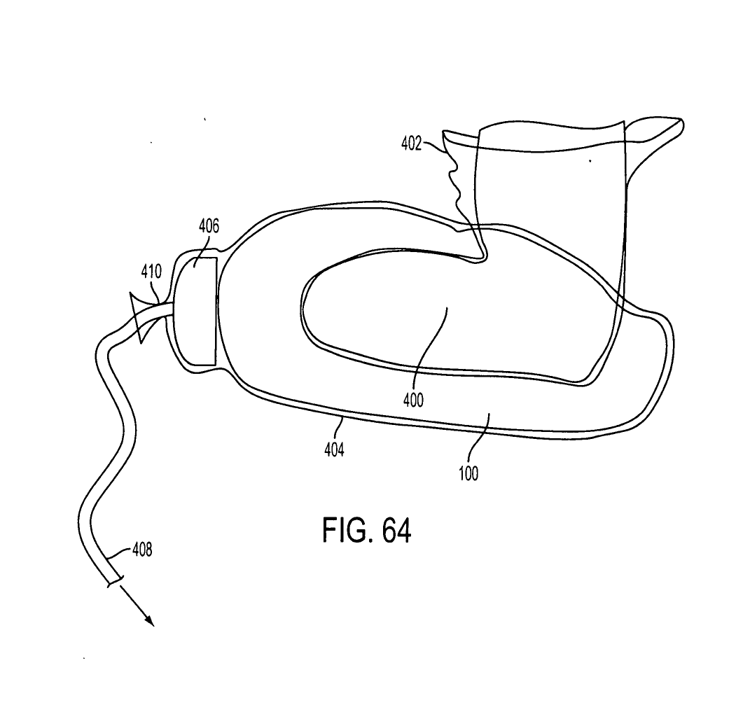

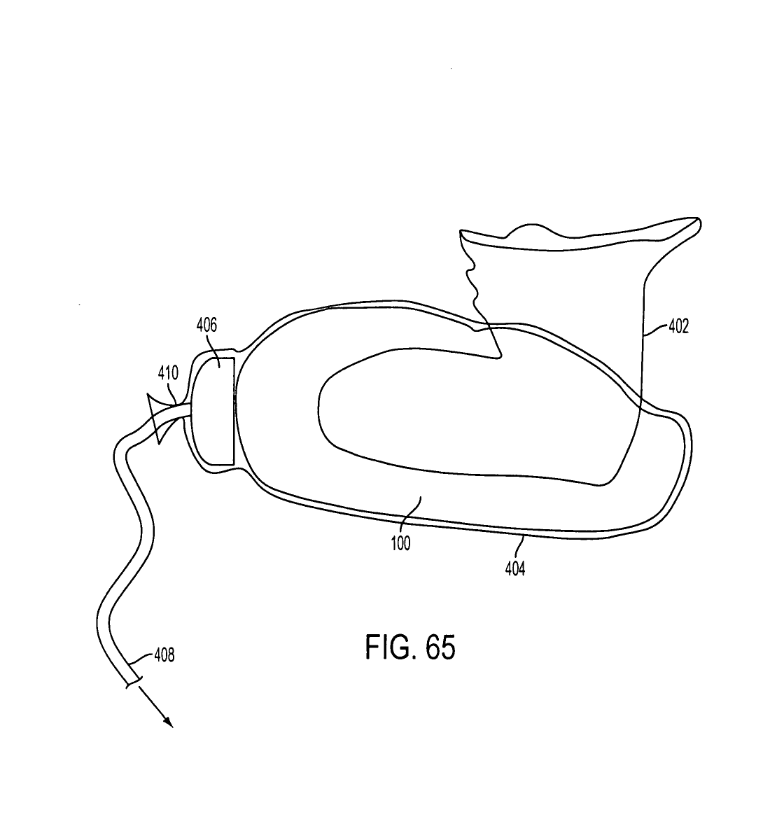

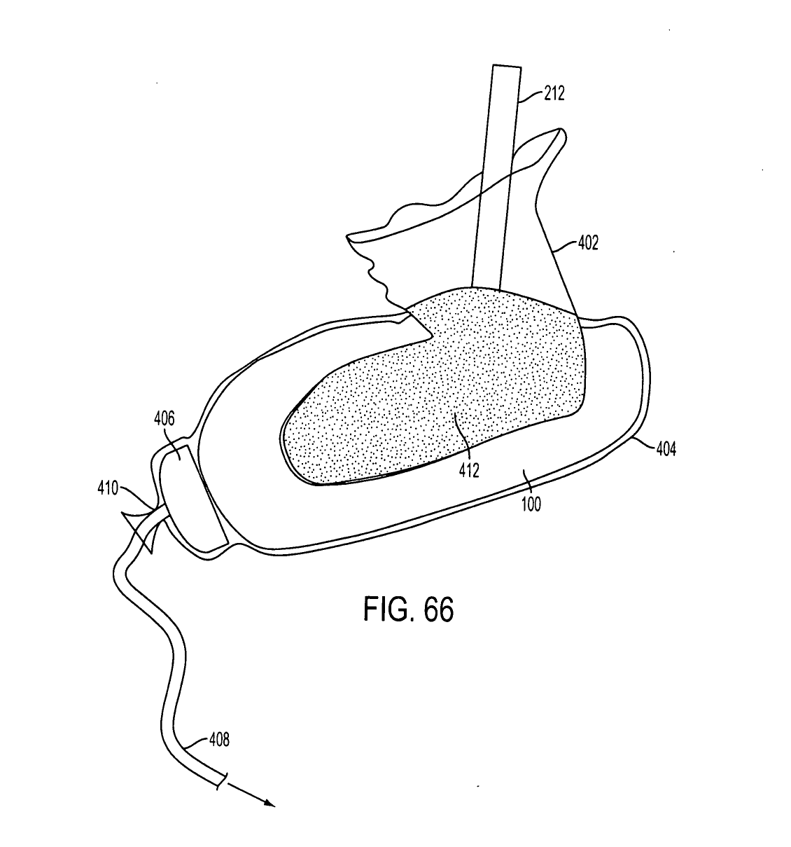

The second plastic bag 404 is then fasted with tape 410, or any other suitable connector, to the air hose 408 on the connector 406 to seal the casting bag 100 as shown in FIG. 63. A vacuum is applied via the connector 406 and air hose 408 to solidify the casting bag 100 to form the negative mold of the residual limb 400 as shown in FIG. 64, and the negative mold is used as a check socket to check the comfort of fitting. If the fitting is comfortable, the residual limb is withdrawn as shown in FIG. 65, and the inner surface of the negative mold can be inspected and smoothed as desired.

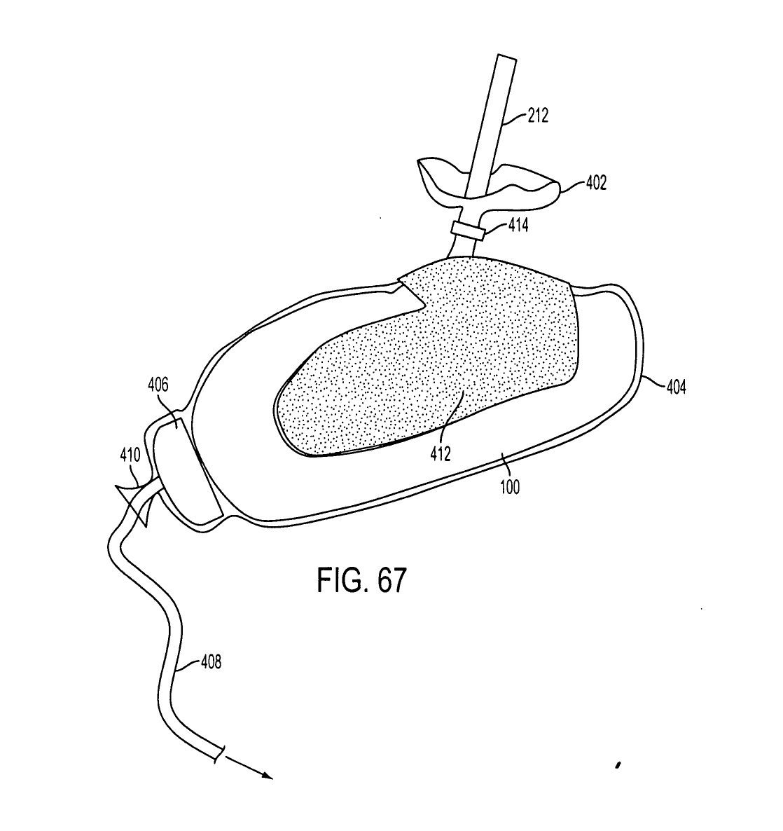

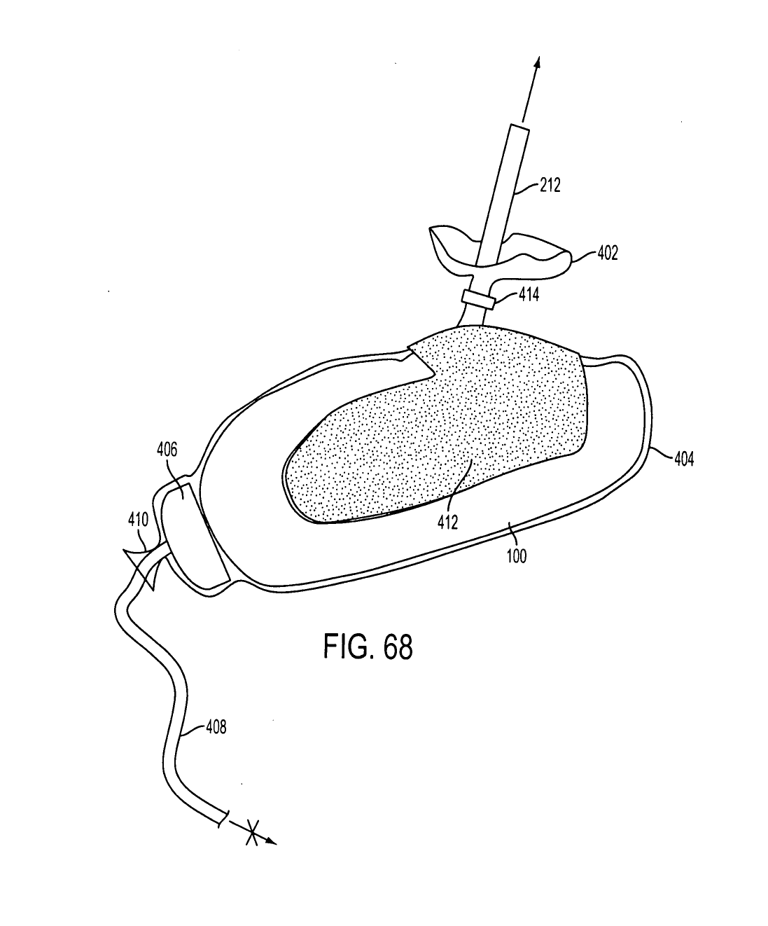

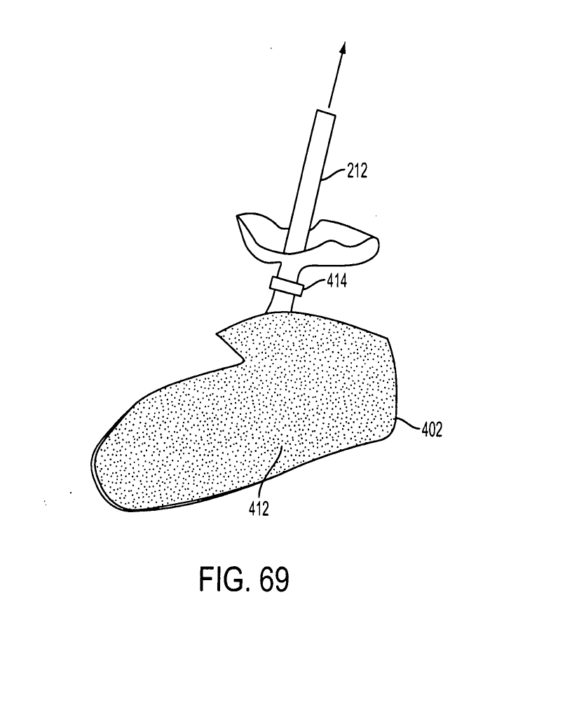

The negative mold can be used to make a positive sand model by filling sand 412 into the void and inserting the mandrel 212 in the middle or substantially in the middle of the sand 412 as shown in FIG. 66. The second plastic bag 404 is coupled onto the mandrel 212 with tape 414 or any other suitable connector. Vacuum suction is applied through the mandrel 212 to solidify the positive sand model 412 as shown in FIG. 67. Then, the vacuum suction is disconnected from the casting bag 100 as shown in FIG. 68. The loosened casting bag 100 and second plastic bag 404 are removed as shown in FIG. 69, and the formed positive sand model 412 can be taken to the laboratory for modification and vacuum forming the socket in a manner consistent with that described above with regard to FIGS. 24-41 and as discussed further in U.S. Pat. No. 6,709,617 to Wu, referenced above.

Casting For Transhumeral Socket

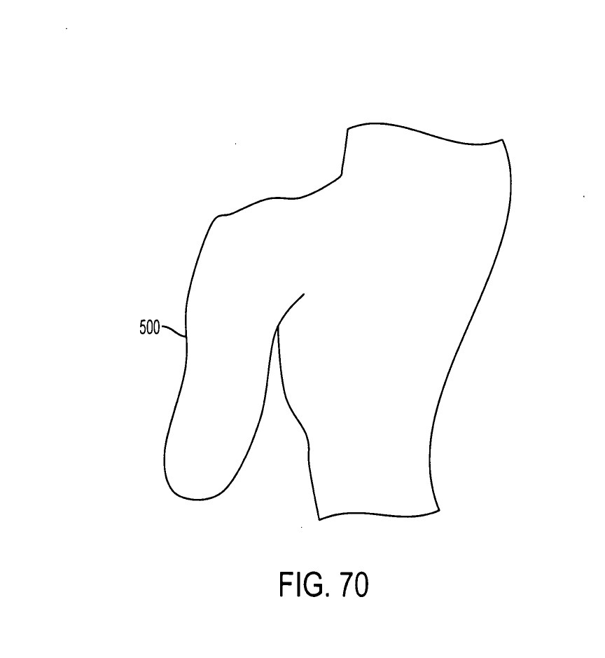

FIGS. 70-86 illustrate an example of a process for making a mold for a transhumeral socket using the casting bag 100 according to an embodiment of the present invention.

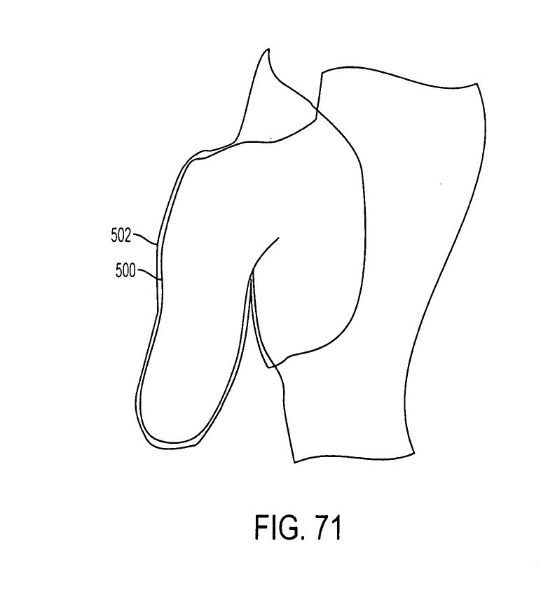

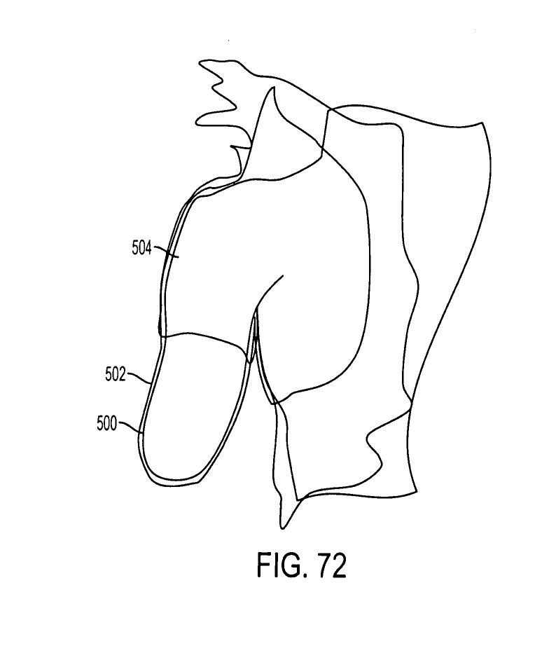

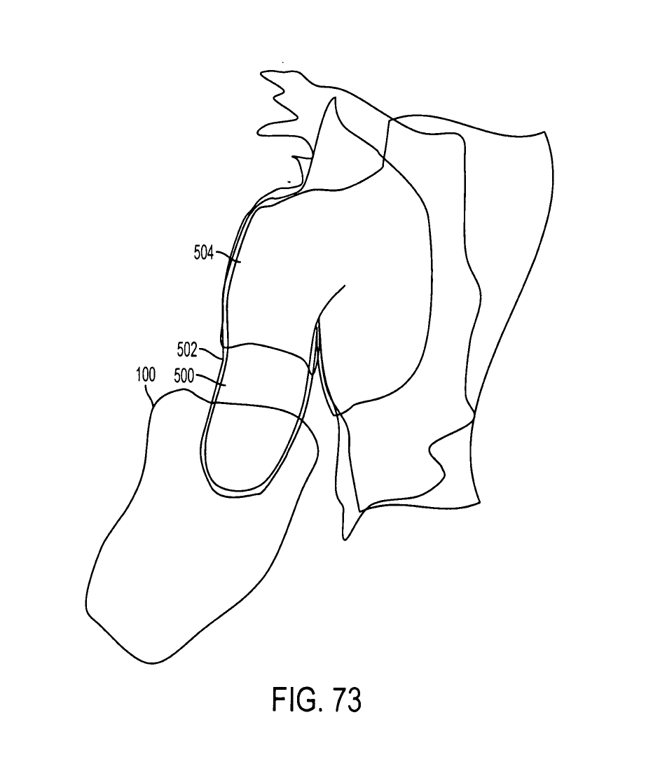

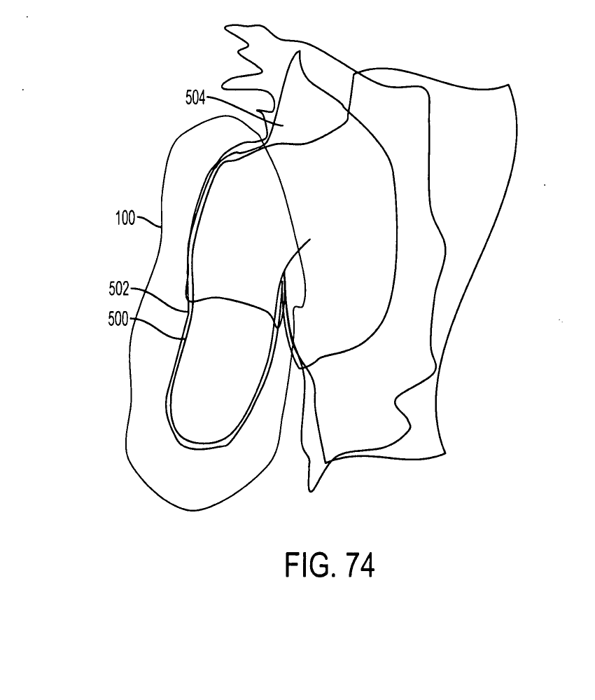

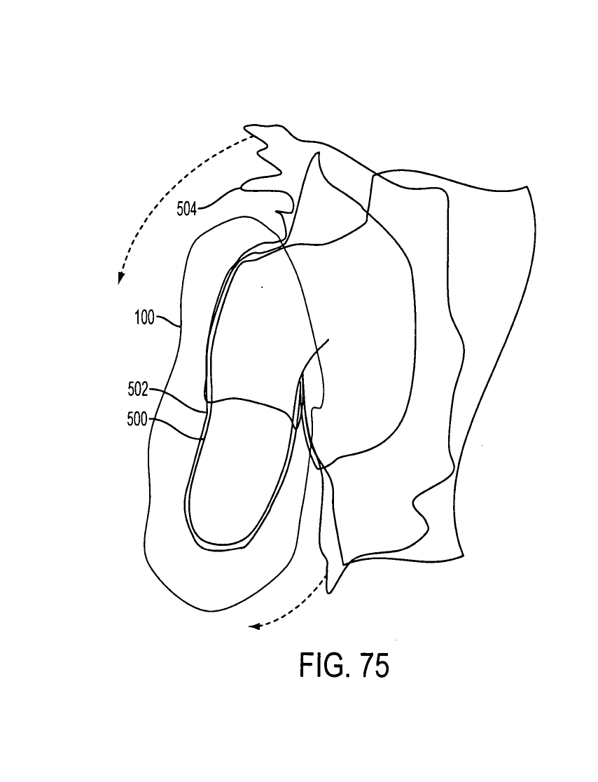

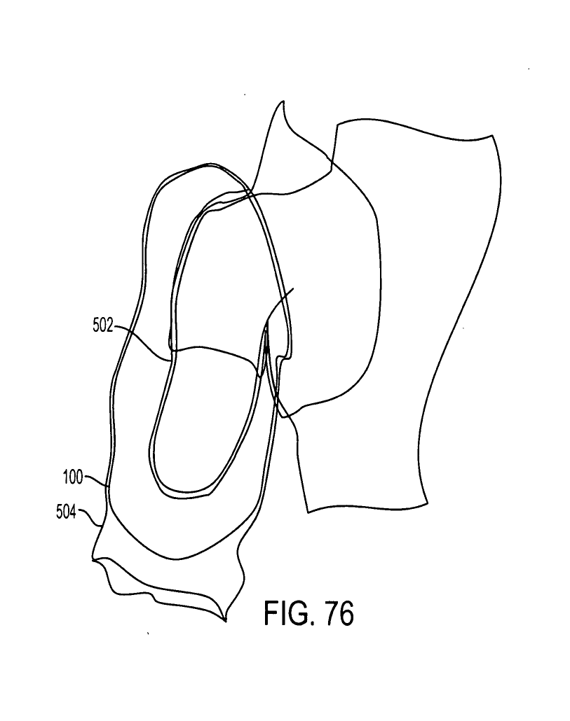

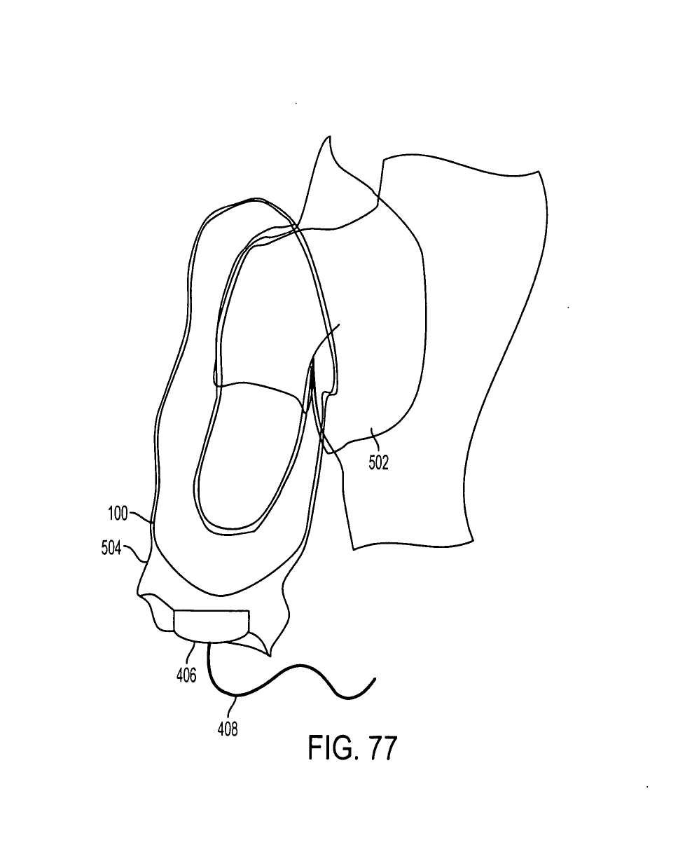

As shown in FIG. 70, a routine patient evaluation is performed and a basic measurement of the residual limb 500 is obtained. A first bag 502, that can be made of plastic or any other suitable material as described above, is placed over the residual limb 500 up above the shoulder as shown in FIG. 71. As shown in FIG. 72, a second bag 504, which can be made of plastic or any other suitable material as discussed above and has a hole at the end, is placed from mid-arm to above the shoulder. The hole in the end of the second bag 504 is sufficient to allow the limb 500 and the first bag 502 to pass therethrough when the second bag 504 is drawn over the limb 500 and the first bag 502. The casting bag 100 can be rolled evenly over the residual limb 500 as shown in FIG. 73 to a location slightly above the socket trim line as shown in FIG. 74. The second plastic bag 504 is then folded downward as shown in FIG. 75, and should be long enough to cover the entire casting bag 100 as shown in FIG. 76.

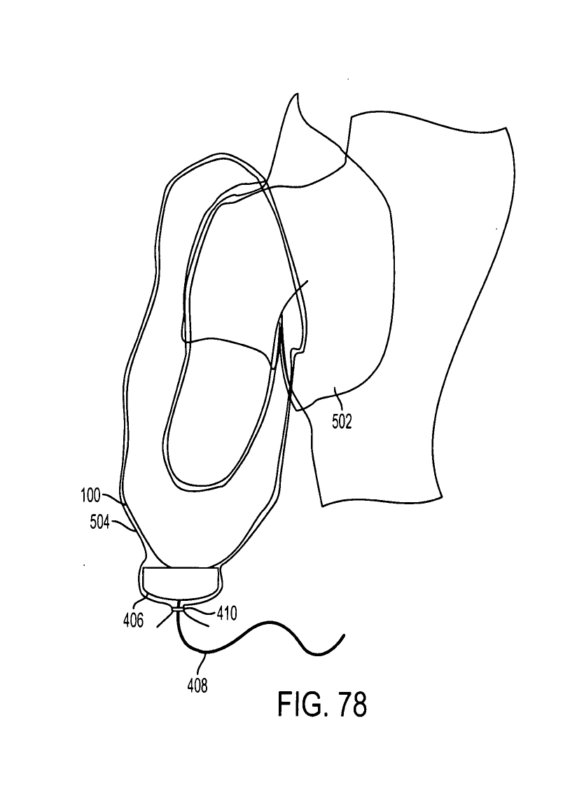

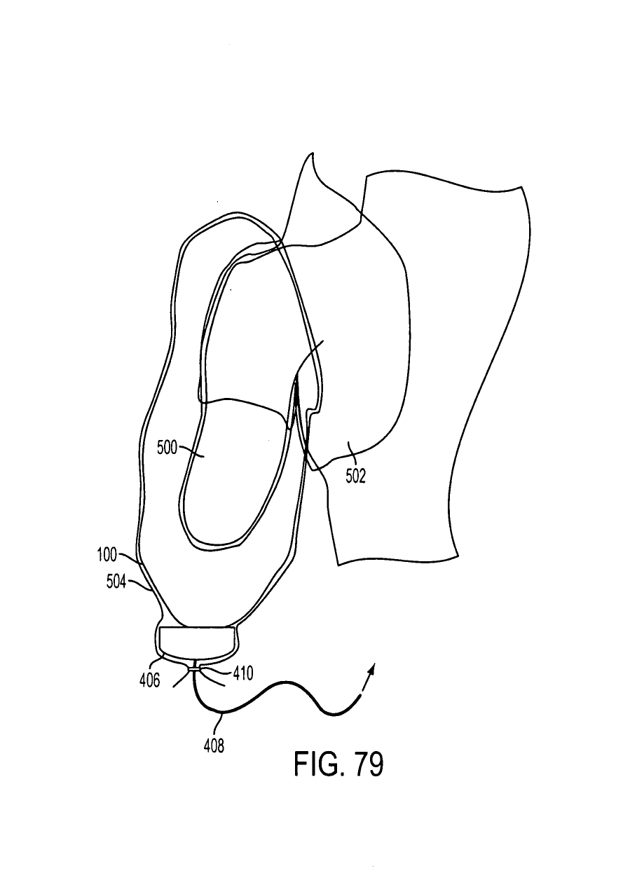

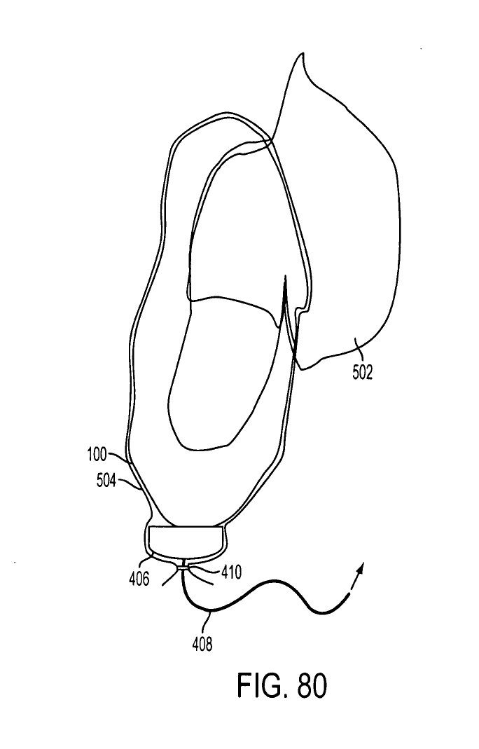

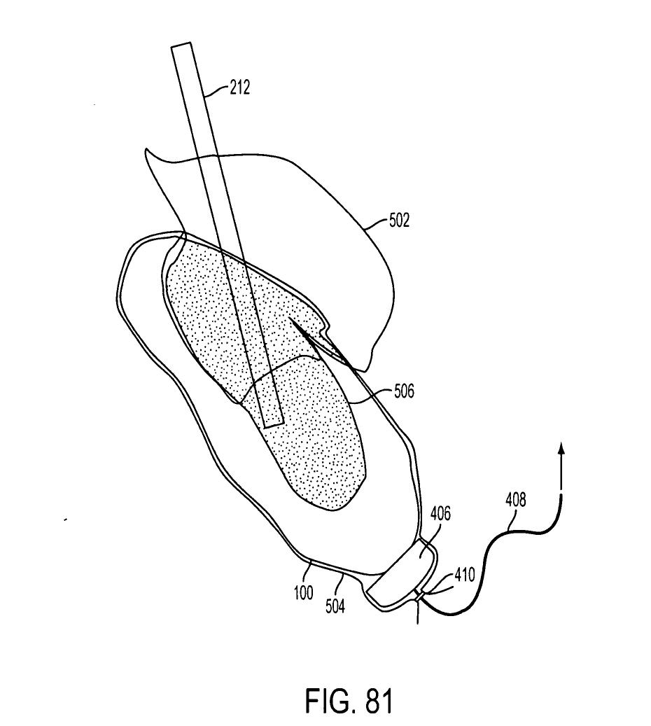

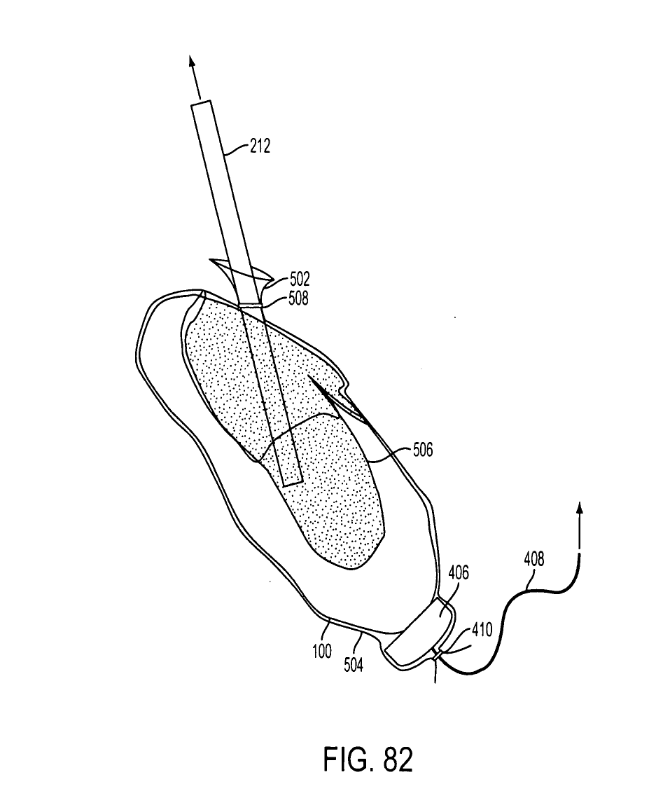

A connector 406 attached to an air hose 408 is then placed at the end of casting bag as shown in FIG. 77. Alternatively, a connector 102 can be used. The second plastic bag 504 is connected by tape 410 or any other suitable connector to the air outlet on the connector 406, or to the air hose 408, to seal the casting bag 100 as shown in FIG. 78. Vacuum suction is applied via the connector 406 and air hose 408 to solidify the casting bag 100 to form the negative mold as shown in FIG. 79. If the fitting of the negative mold is comfortable, the residual limb 500 is withdrawn as shown in FIG. 80. As shown in FIG. 81, the void in the negative mold is filled with sand 506 to its brim and the mandrel 212 is placed in the middle or substantially in the middle of the sand 506. The first plastic bag 502 can be connected by tape 508 or any other suitable connector onto the mandrel 212 as shown in FIG. 82, and a vacuum suction is applied via the mandrel 212 to solidify the positive sand model 506.

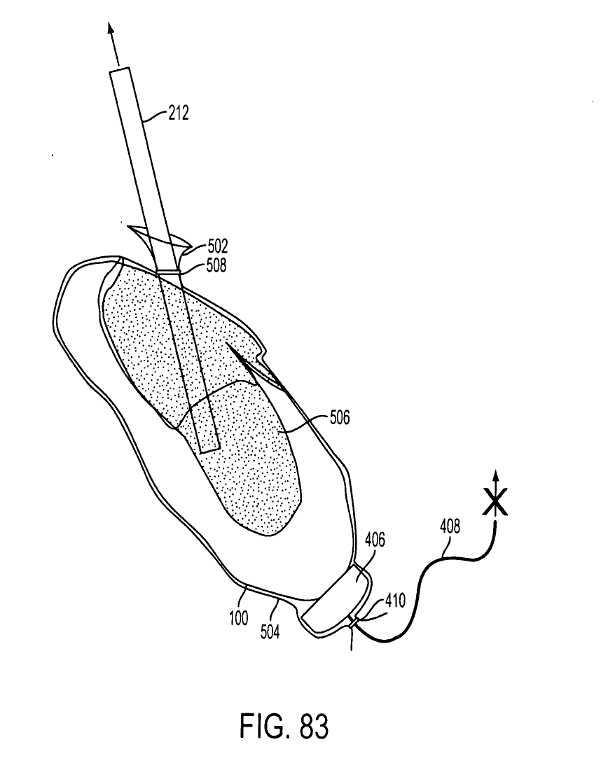

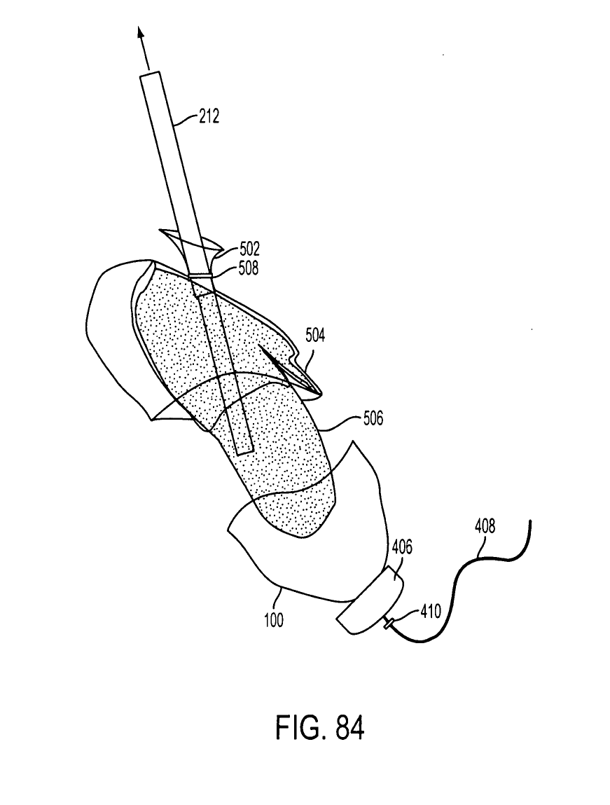

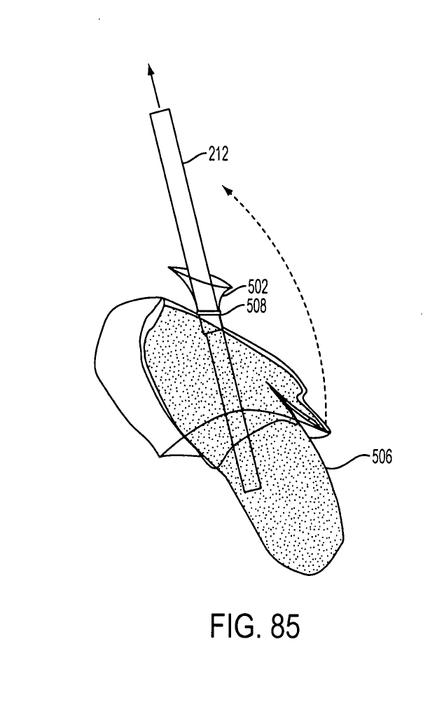

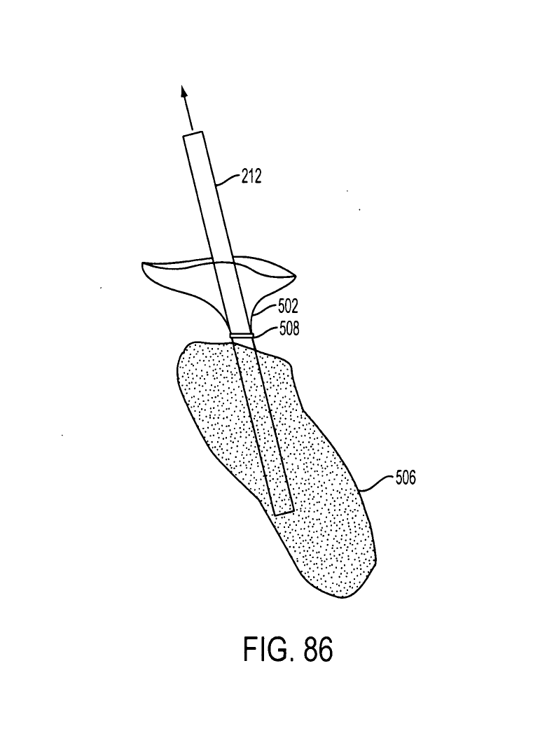

As shown in FIG. 83, the vacuum is disconnected from the casting bag 100 to loosen the casting bag 100, and the connector 406, second plastic bag 504 and casting bag 100 are removed as shown in FIG. 84. The first plastic bag 502 is then pushed upward as shown in FIG. 85, and connected by tape or any other suitable connector to the mandrel 212. This positive sand model 506 as shown in FIG. 86 can then be moved to the laboratory for modification and vacuum forming of the socket in a manner consistent with that described above with regard to FIGS. 24-41 and as discussed further in U.S. Pat. No. 6,709,617 to Wu, referenced above.

Casting For a Shoe Insert

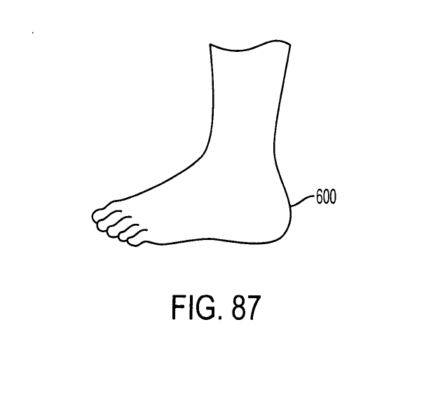

FIGS. 87-100 illustrate an example of a process for making a mold for a shoe insert using the casting bag 100 according to an embodiment of the present invention.

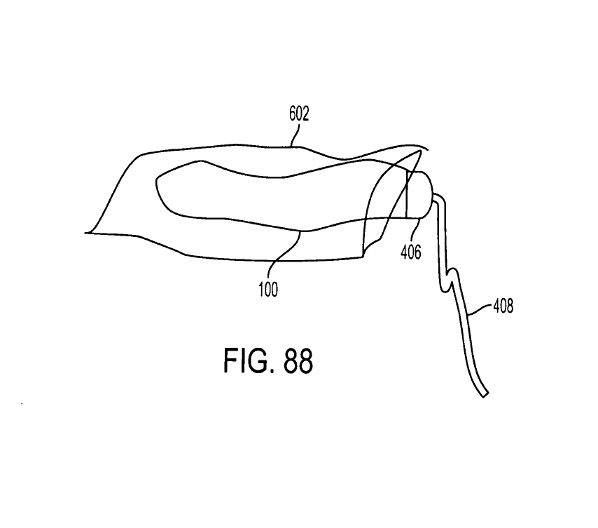

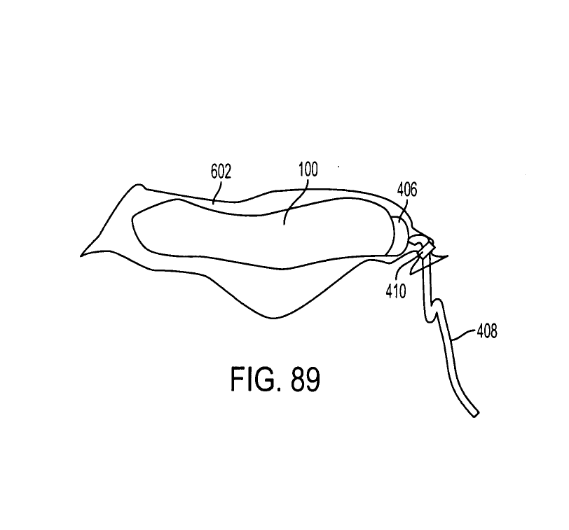

As with the above processes, a routine patient evaluation is performed and a basic measurement of the foot 600 is obtained as shown in FIG. 87. As shown in FIG. 88, the casting bag 100 is placed inside a bag 602, which can be made of plastic or any other suitable material as discussed above. Then, a connector 406 (or 102) with air hose 406 are attached to the end of the casting bag 100. As shown in FIG. 89, the casting bag 100 is entirely covered with the plastic bag 602, and then the plastic bag 602 is connected by electrical tape 410 or any other suitable connector to the connector 406 or air hose 408.

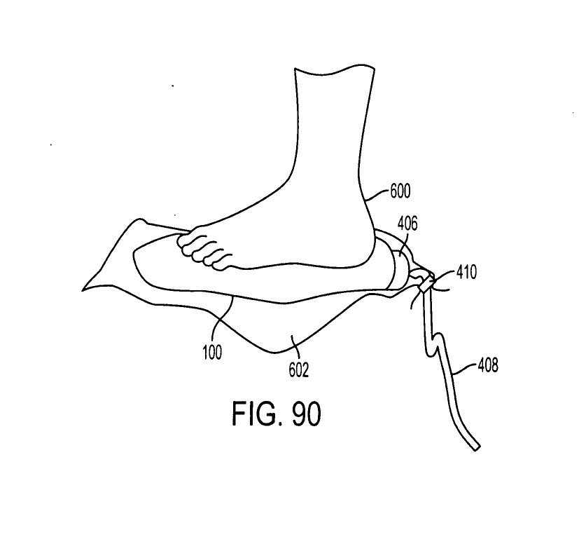

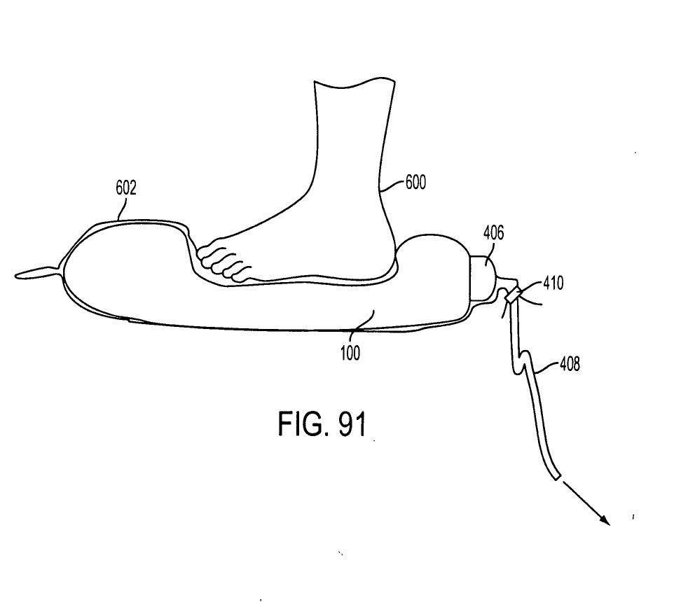

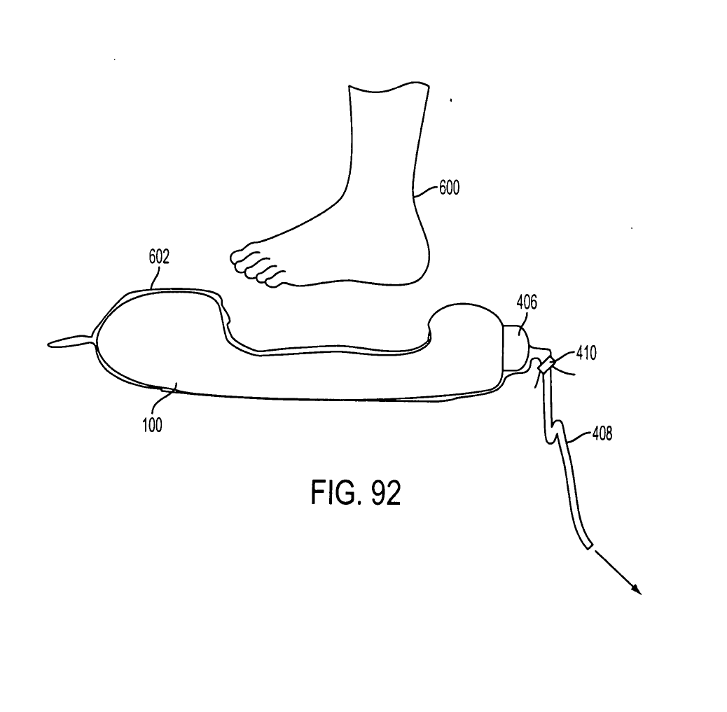

As shown in FIG. 90, the foot 600 can be gently pressed to be cast into the casting bag 100, which is covered by the plastic bag 602. Vacuum suction is then applied as in FIG. 91 to solidify the casting bag 100, which will result in an impression of the foot 600. The foot 600 is withdrawn as shown in FIG. 92, and the negative mold of the foot can be checked for any wrinkles and the surface can be smoothed as needed.

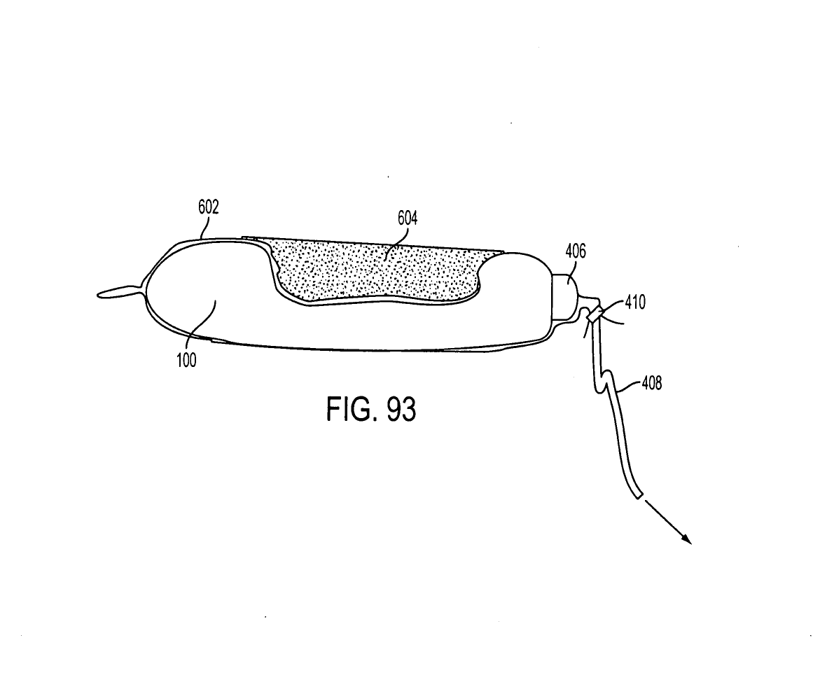

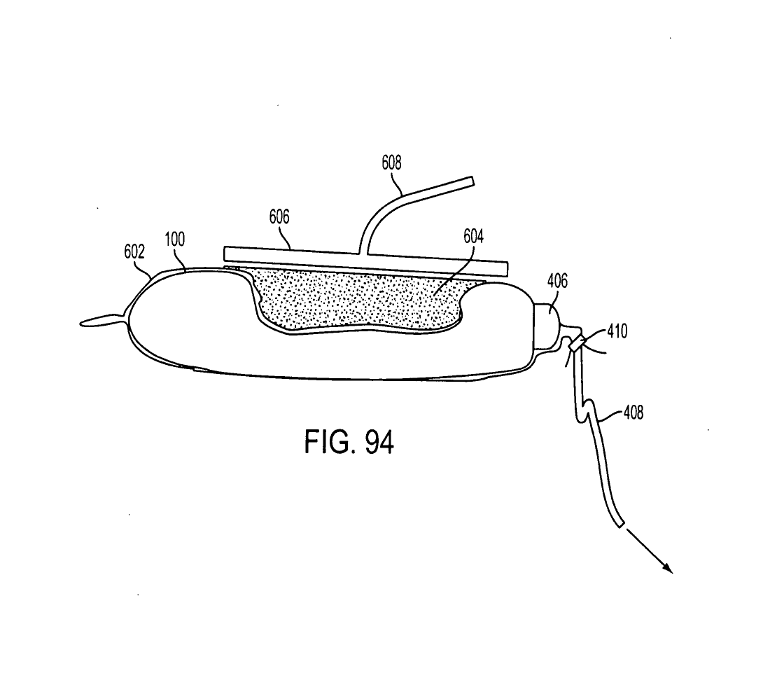

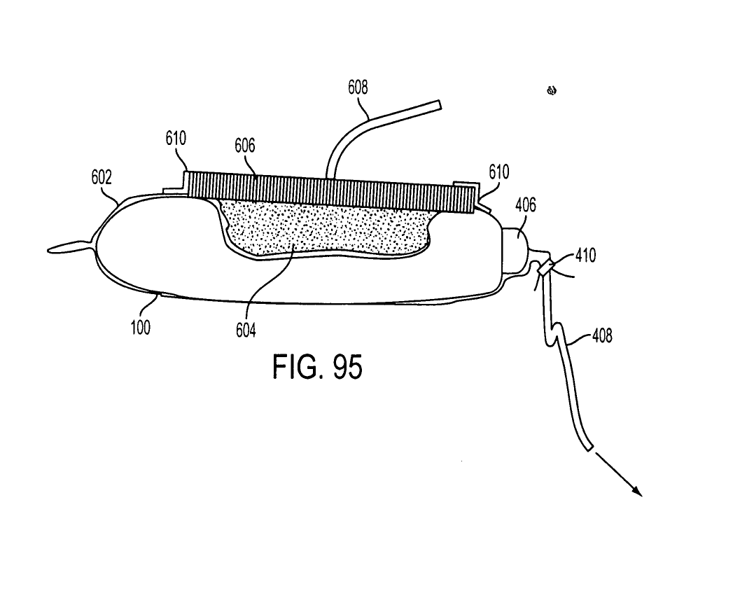

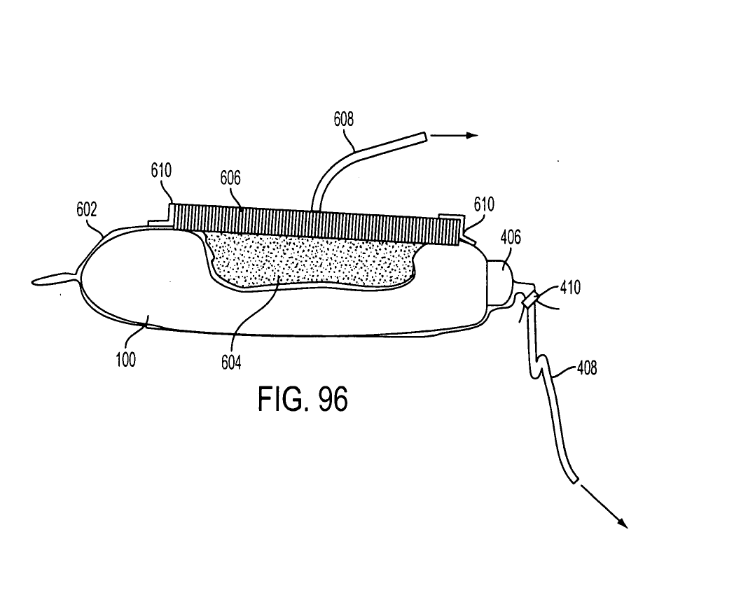

The negative mold is then filled with sand 604 as shown in FIG. 93, and a connector 606 with an air outlet hose 608 that can be for connected to the vacuum pump is applied to the sand 604 as shown in FIG. 94. Electric tape 610, or any other suitable connector, can then be used to seal the gap between the connector 606 and the plastic bag 602 covering the casting bag 100 as shown in FIG. 95, and vacuum suction is applied as shown in FIG. 96 to solidify the sand 604 to create a positive sand model.

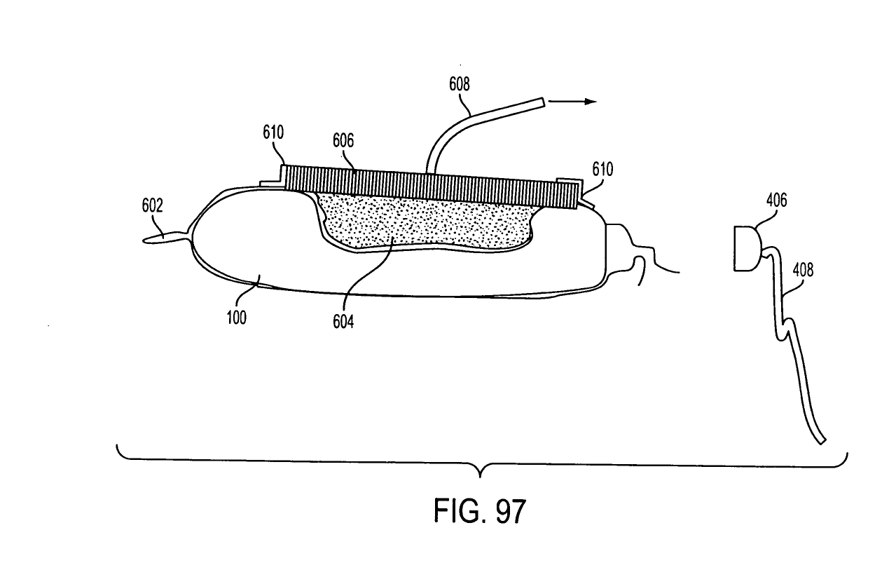

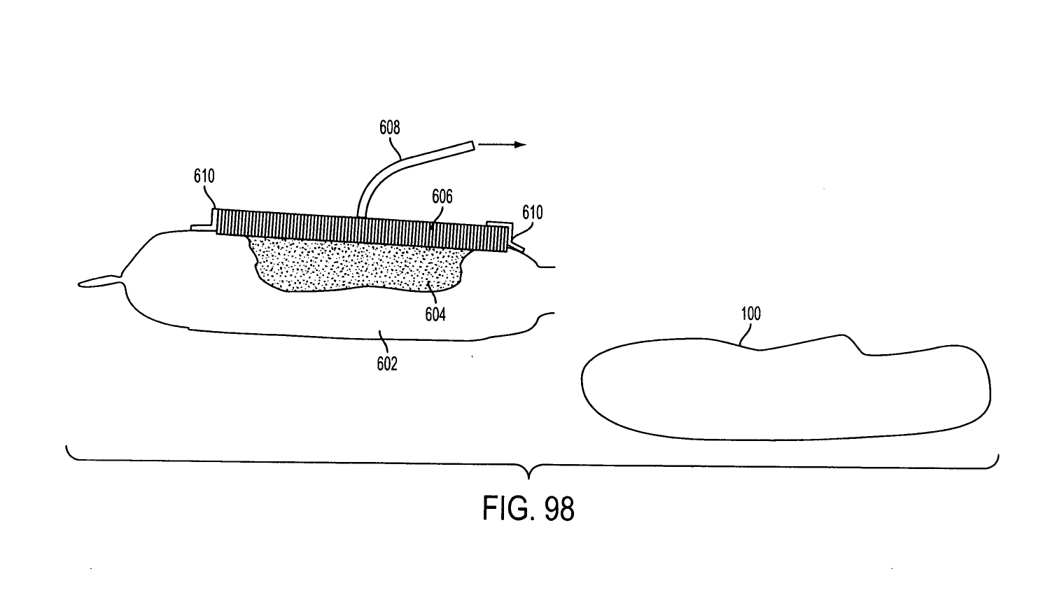

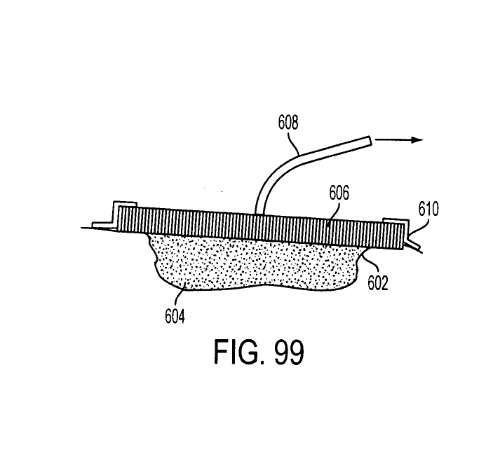

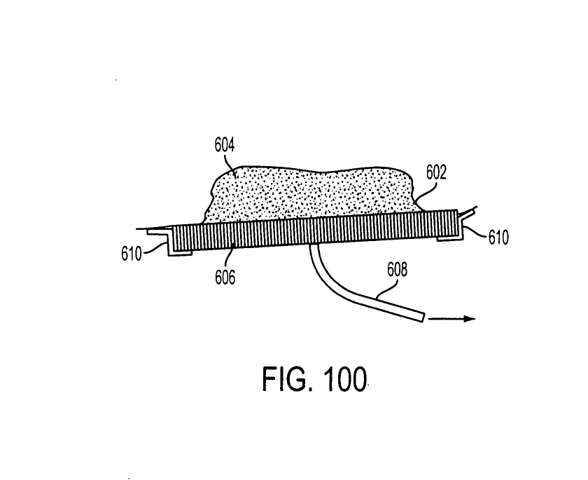

The vacuum suction is then disconnected from the casting bag 100 and the connector 406 is removed as shown in FIG. 97. The plastic bag 602 is then opened and the casting bag 100 is removed as shown in FIG. 98. Excessive parts of the plastic bag 602 are cut away as shown in FIG. 99, and the positive sand model can be inverted as shown in FIG. 100, and then modified as desired and used for vacuum forming the shoe insert in a manner consistent with that described above with regard to FIGS. 24-41 and as discussed further in U.S. Pat. No. 6,709,617 to Wu, referenced above.

Casting For an Ankle Foot Orthesis

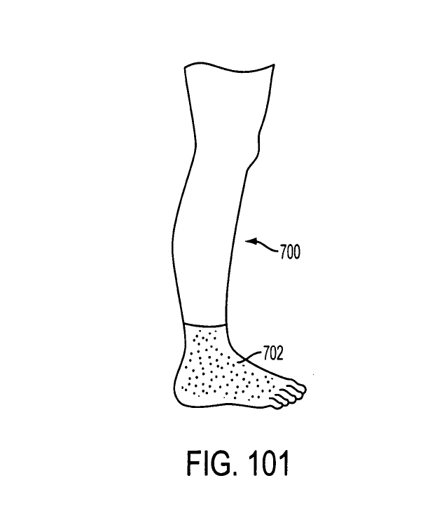

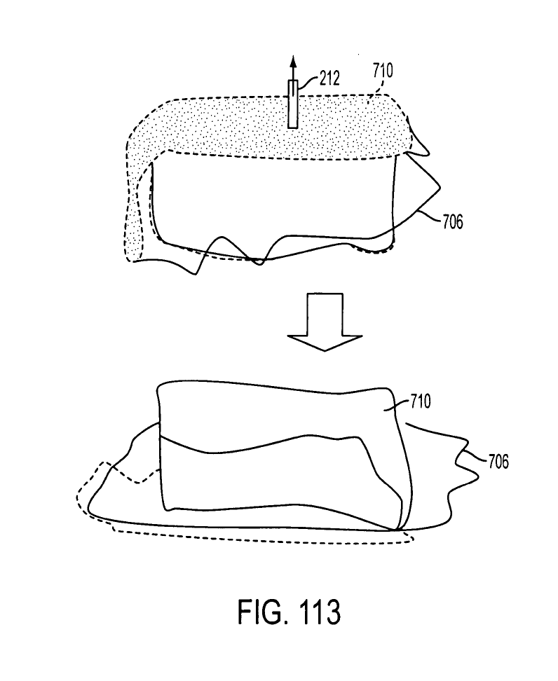

FIGS. 101-113 illustrate an example of a process for making a mold for casting an ankle foot orthesis using the casting bag 100 according to an embodiment of the present invention.

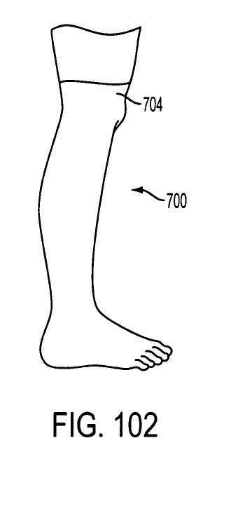

As in the processes described above, a routine patient evaluation is performed and a basic measurement of the leg 700 is obtained. Water-based clay 702, for example, or any other suitable material can be used to build up pressure relief over the bony areas as shown in FIG. 102. A layer of sheath 704 made of nylon or any other suitable material can be laid over the leg 700 to keep the clay build ups from being displaced.

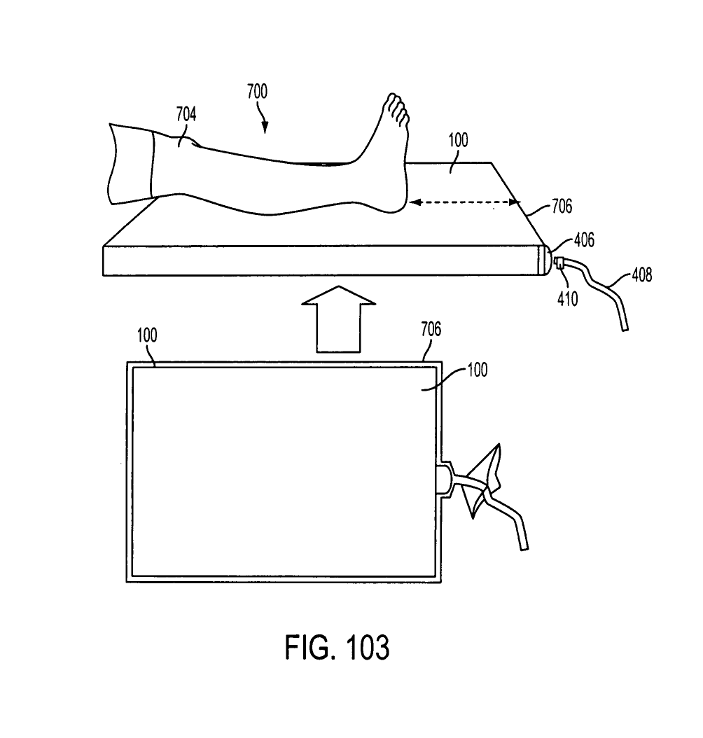

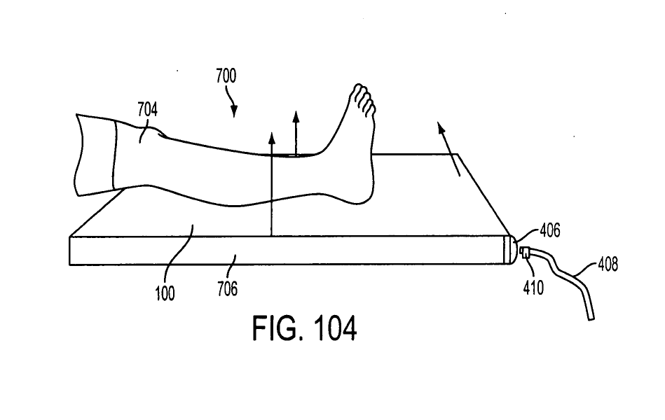

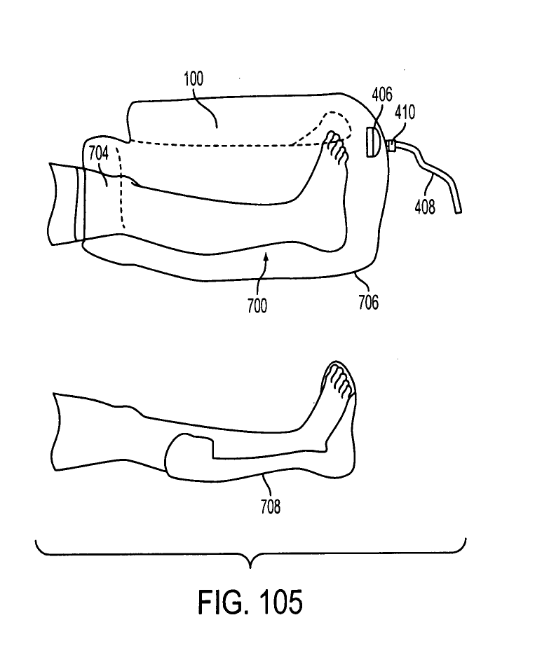

The casting bag 100 is placed in a bag 706 made of plastic or any other suitable material, and the connector 406 (or 102) with the hose 408 are connected to the casting bag 100 and the plastic bag 706 is connected to the connector 406 or hose 408 using tape 410 or any other suitable connector. The leg 700 can then be placed on the surface (e.g., in the middle) of the casting bag 100 assembly as shown in FIG. 103 in a manner to allow enough space distal to the foot. The casting bag 100 is folded up on both the medial, lateral and plantar sides over to the leg 700 as shown in FIG. 104. Specifically, the area of the leg 700 covered by the casting bag 100 should be at least slightly larger than the ankle foot orthosis 708 to be made as shown in FIG. 105.

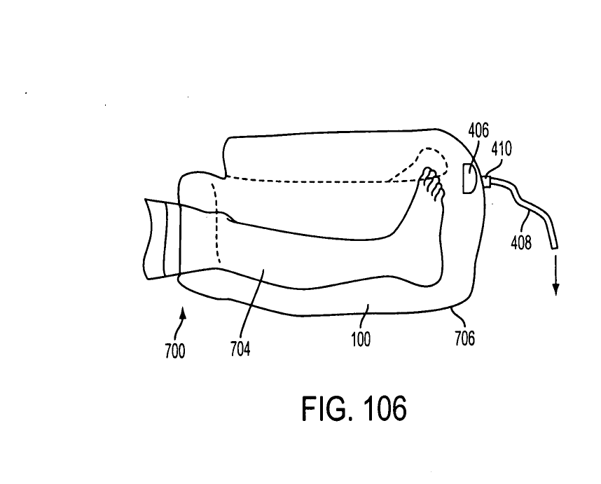

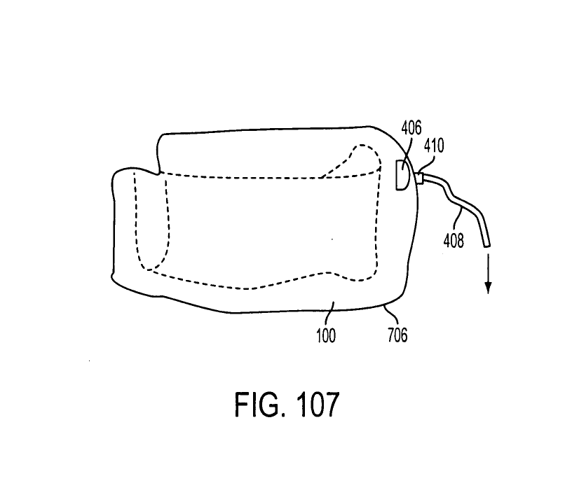

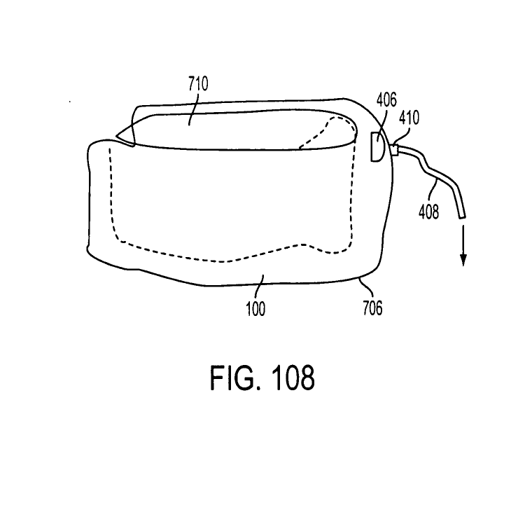

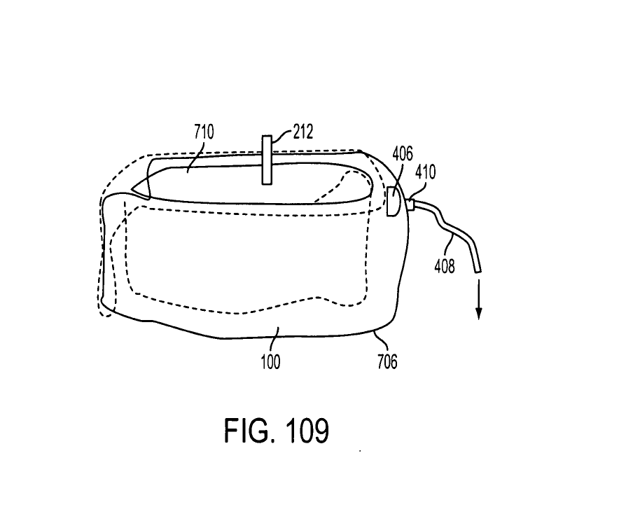

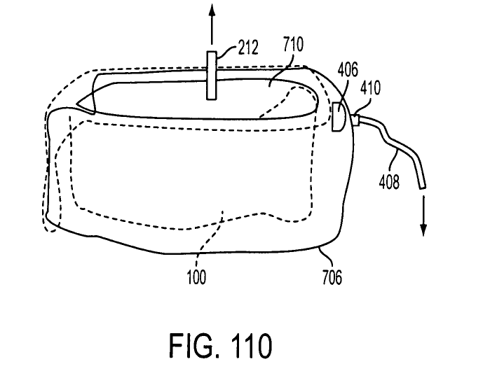

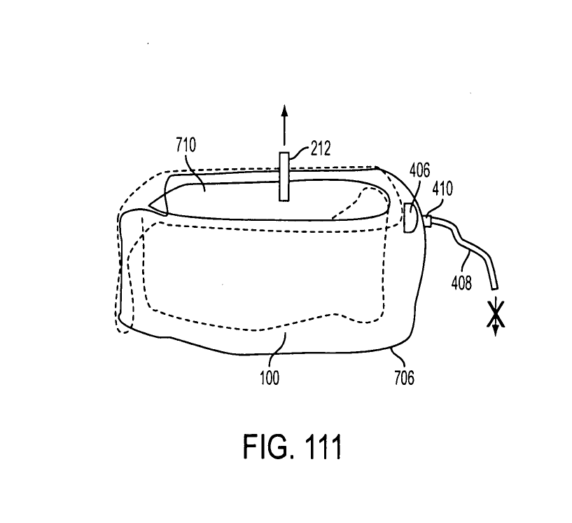

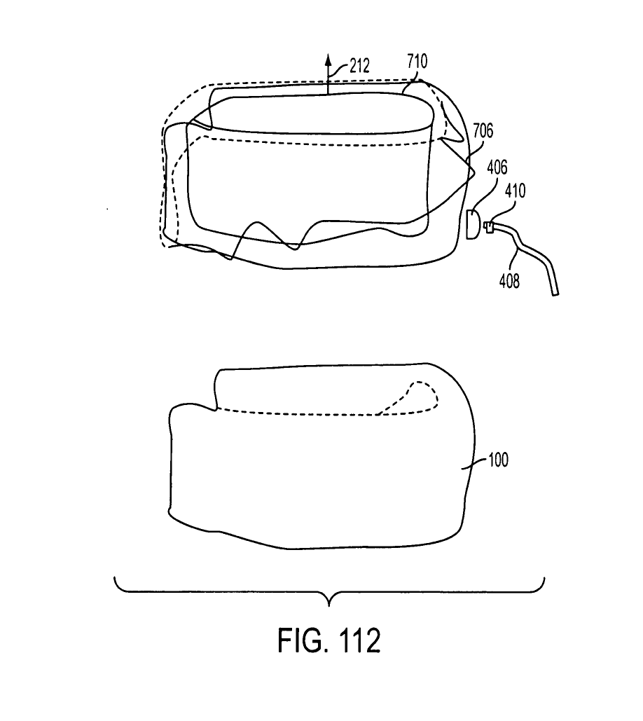

Vacuum suction is then applied via the connector 406 and hose 408 to solidify the casting bag 100 as shown in FIG. 106. Once the casting bag 100 is solid, the patient withdraws the limb 700 as shown in FIG. 107. While maintaining the casting bag 100 in solid form under vacuum, the cavity is filled with sand 710 as shown in FIG. 108. The mandrel 212 is then inserted into the sand 710 and the sand 710 is sealed with a large plastic film 712 to the casting bag 100 as shown in FIG. 109. Vacuum suction is then applied through the mandrel 212 to solidify the sand 710 and turn the sand 710 into a positive model as shown in FIG. 110. While maintaining the vacuum to positive model 710, the vacuum suction is disconnected from the casting bag 100 as shown in FIG. 111. The plastic bag 702 is then cut, and the connector 406 is removed and the casting bag 100 is pulled out of the plastic bag 702, leaving the cut plastic bag 702 behind as shown in FIG. 112. The vacuum suction is maintained via the mandrel 212, and the positive sand model 710 can then be inverted. The positive sand model 710 can be taken to the laboratory for modification and forming the ankle foot orthosis in a manner consistent with that described above with regard to FIGS. 24-41 and as discussed further in U.S. Pat. No. 6,709,617 to Wu, referenced above.

Casting For a Body Jacket

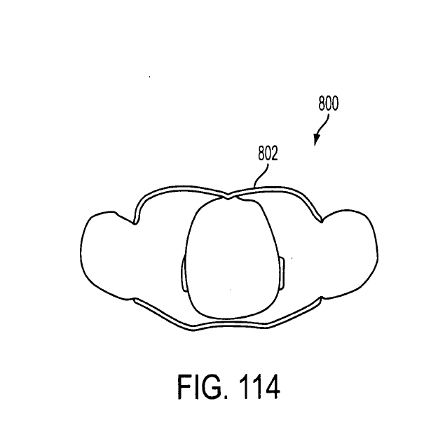

FIGS. 114-124 illustrate an example of a process for making a mold for casting a body jacket using the casting bag 100 according to an embodiment of the present invention.

As with the processes described above, a routine patient evaluation is performed and a basic measurement of the body trunk 800 is taken as shown in FIG. 114. A casting stocking 802 is placed on the trunk 800, and a build up of cotton, clay or any other suitable material can be added to the casting stocking for pressure relief prior to casting.

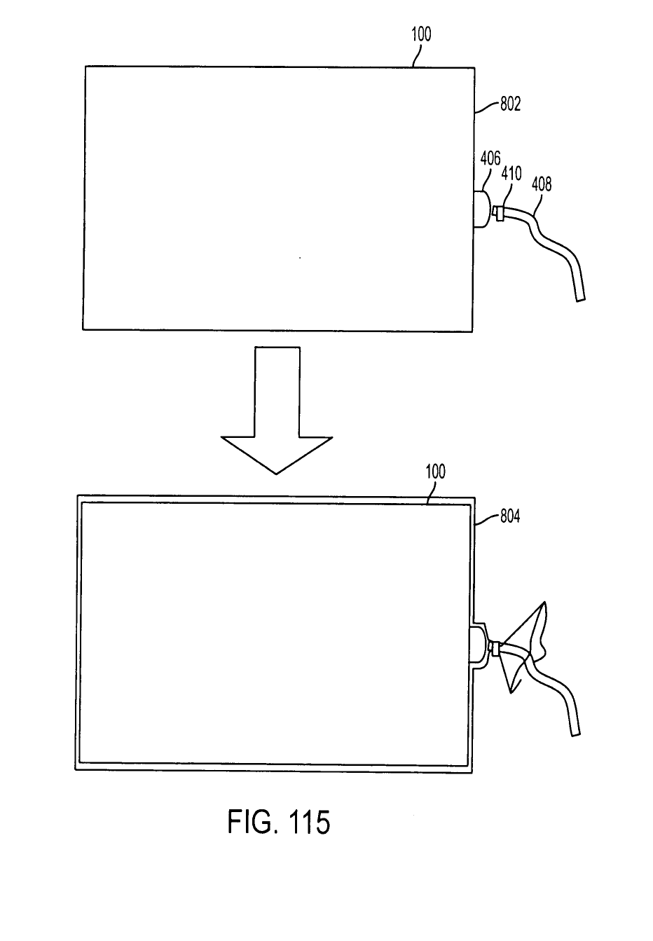

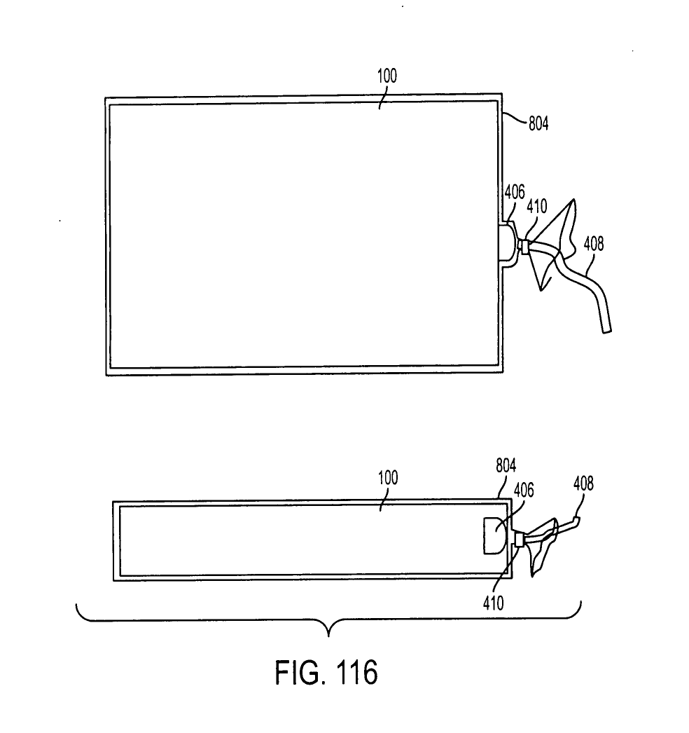

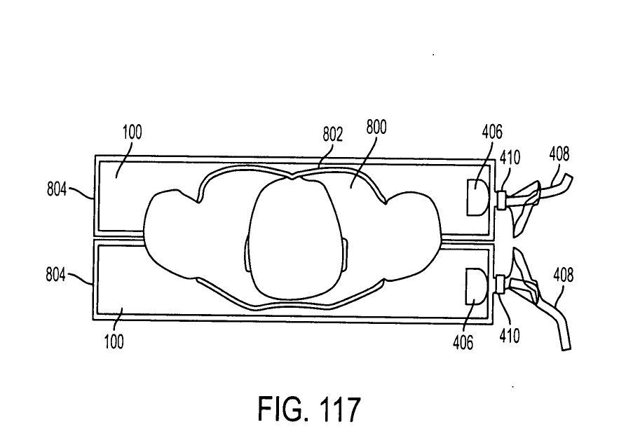

As shown in FIG. 115, a connector 406 (or 104) having hose 408 is placed at the edge of a large casting bag 100. The casting bag 100 is placed in a large bag 804 made of plastic or any other suitable material as discussed above, and the bag 804 is connected to the hose 408 or connector 406 by tape 410 or any other suitable connector as shown in FIG. 116. For the purpose of this example, the connector 406 and air outlet are shown as embedded in the casting bag 100. The combination of the casting bag 100, plastic bag 804, connector 406, hose 408 and tape 410 can be referred to as a casting bag assembly. As shown in FIG. 117, a first casting bag assembly is placed on a table and the patient can lie on the casting bag assembly. A second casting bag assembly can then be placed on the front of the body. Both casting bag assemblies should be positioned between the lower neck and the pubic bone.

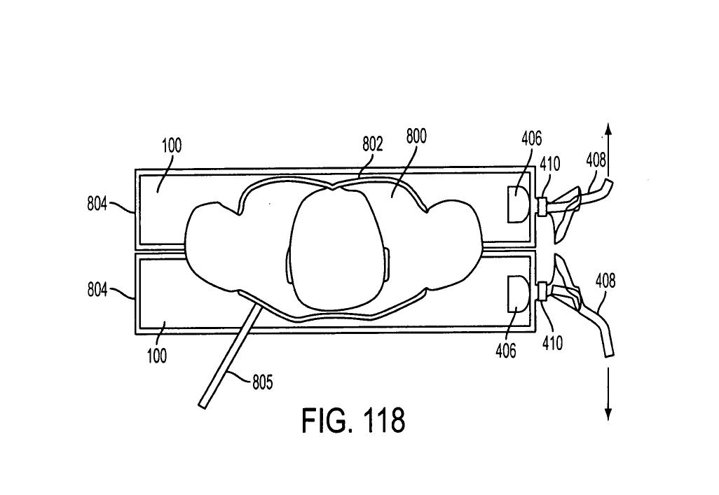

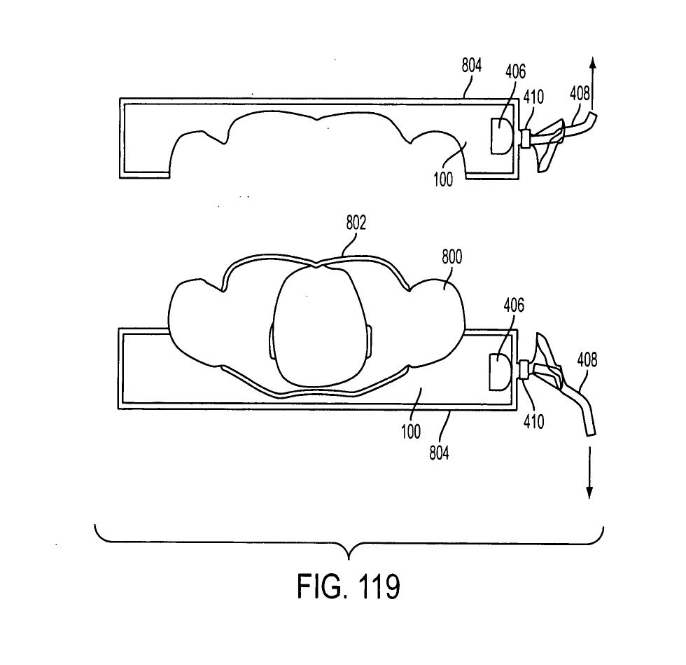

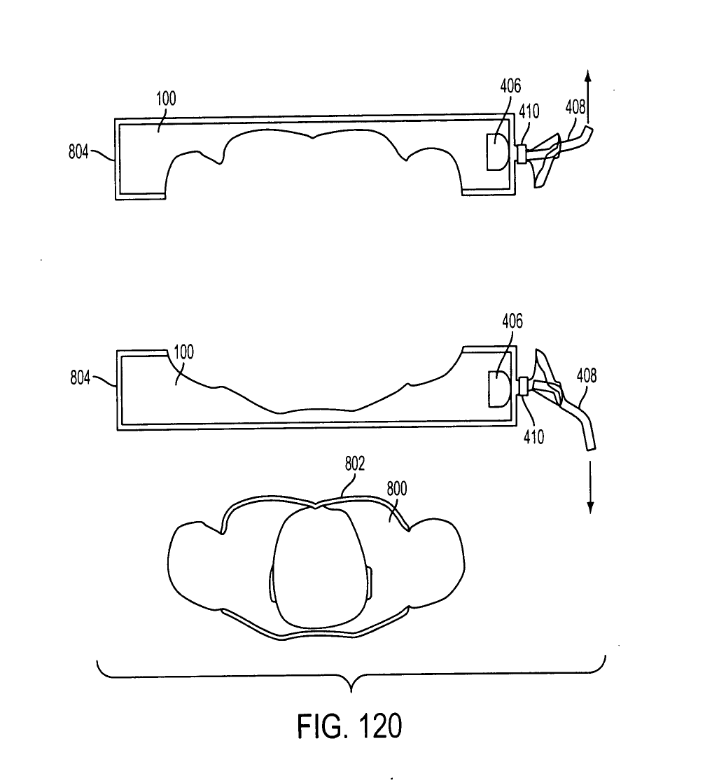

Vacuum suction is then applied via, for example, a tube 805 as shown in FIG. 118 to evacuate the air under the casting stocking 802 so that both casting bag assemblies will have intimate contact on the trunk 800. The patient's comfort within the casting bags assemblies can be check, and if no discomfort is reported, the second casting bag assembly can be removed as shown in FIG. 119. The patient can then come out of the first casting bag assembly without disturbing the lower mold created by the first casting bag assembly as shown in FIG. 120.

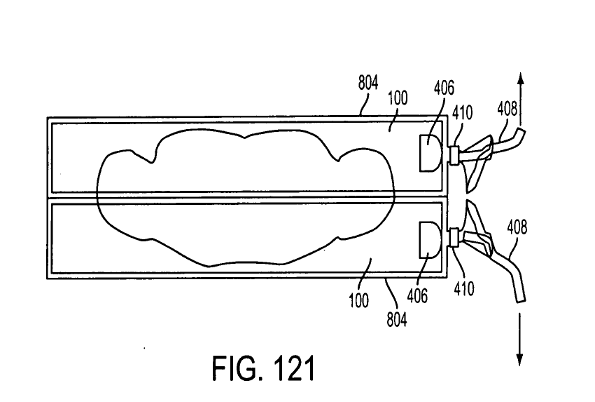

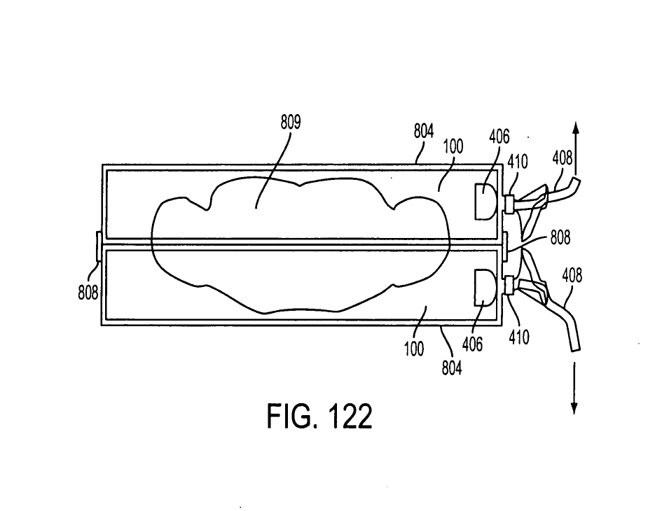

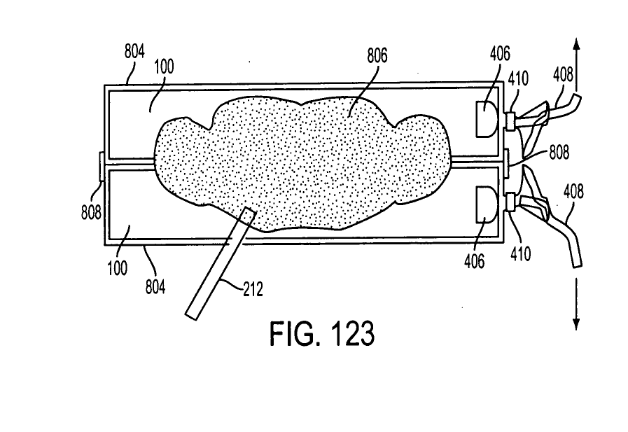

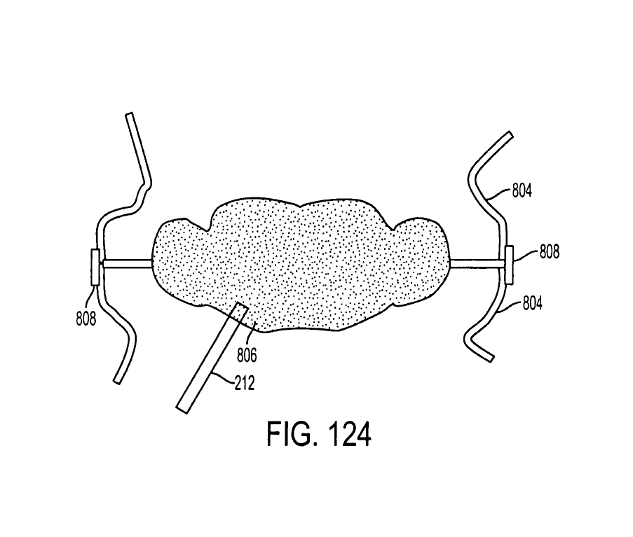

The two casting bag assemblies are then placed together as shown in FIG. 121 to form the negative mold of the body trunk 800. The two casting bag assemblies can then be connected together from the outside by tape 808 or any other suitable connector, and the bottom of the negative mold (e.g., over the area from which the pelvic region of the patient protruded) is covered with another bag (not shown) made of plastic or any other suitable material as shown in FIG. 122. Once the negative mold is prepared, the negative mold can be used to make a positive sand model by filling the void with sand 806 as shown in FIG. 123. The sand 806 is then sealed by the adjacent casting bag assemblies, and another plastic bag (not shown) that is placed on top of the negative mold (e.g., over the area from which the head and neck region of the patient protruded) to form the solid positive sand model 806. While the positive sand model 806 is maintained solid under vacuum suction, the vacuum is disconnected from the casting bag assemblies, the bags 804 are cut, and both casting bags 100 are removed. After trimming the redundant plastic bags as shown in FIG. 124, the rest of the plastic bags 804 are folded onto the positive sand model 806. The positive sand model 806 can be then modified, and a body jacket can be vacuum formed in a manner consistent with that described above with regard to FIGS. 24-41 and as discussed further in U.S. Pat. No. 6,709,617 to Wu, referenced above.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for making a mold of an object, comprising:
placing a flexible bag, which is breathable to a gas and has conformable material therein, proximate to at least a portion of the object;
applying vacuum suction to the flexible bag to cause the flexible bag to compress the conformable material therein such that a surface of the flexible bag proximate to the portion of the object substantially conforms to the shape of the portion of the object.

2. A method as claimed in claim 1, wherein:
the conformable material includes polystyrene beads.

3. A method as claimed in claim 1, further comprising:
removing the flexible bag from proximity to the object while continuing to apply the vacuum suction to the flexible bag, to enable the flexible bag to maintain a negative mold of the portion of the object.

4. A method as claimed in claim 3, further comprising:
depositing a material into the negative mold to form a positive mold of the portion of the object.

5. A method as claimed in claim 1, wherein:
the flexible bag is shaped to define a recess therein; and
wherein the placing step includes placing the portion of the object within the recess.

6. A method as claimed in claim 1, further comprising:
placing a conformable material over the portion of the object prior to placing the flexible bag proximate to the portion of the object; and
wherein the step of placing the flexible bag proximate to the object includes placing the flexible bag in contact with the conformable material.

7. A method as claimed in claim 6, wherein:
the conformable material comprises plastic.

8. A method as claimed in claim 6, further comprising:
removing the object from contact with the conformable material and proximity with the flexible bag while continuing to apply the vacuum suction to the flexible bag, to enable the flexible bag and conformable material to maintain a negative mold of the portion of the object.

9. A method as claimed in claim 8, further comprising:
depositing a material into the negative mold;
applying a vacuum suction to the material in the negative mold to form a positive mold of the portion of the object.

10. A method as claimed in claim 9, further comprising:
discontinuing the vacuum suction on the flexible bag and removing the flexible bag from contact with the conformable material, such that the conformable material and the material in the negative mold form the positive mold.

11. A method as claimed in claim 1, wherein:
the flexible bag includes at least one of Spandex and nylon.

12. A system for making a mold of an object, comprising:
a flexible bag, which is breathable to a gas and has conformable material therein, and is configured for placement proximate to at least a portion of the object, such that when vacuum suction is applied to the flexible bag, the flexible bag compresses the conformable material therein such that a surface of the flexible bag proximate to the portion of the object substantially conforms to the shape of the portion of the object.

13. A system as claimed in claim 12, wherein:
the conformable material includes polystyrene beads.

14. A system as claimed in claim 12, further comprising:
a device for applying the vacuum suction to the flexible bag.

15. A system as claimed in claim 12, wherein:
the flexible bag defines a recess therein, configured to receive the portion of the object within.

16. A system as claimed in claim 12, further comprising:
a conformable material, configured for placement over the portion of the object prior to placing the flexible bag proximate to the portion of the object.

17. A system as claimed in claim 16, wherein:
the conformable material comprises plastic.

18. A system as claimed in claim 12, further comprising:
a connector, configured to couple to the flexible bag to apply the vacuum suction therethrough.

19. A system as claimed in claim 12, wherein:
the flexible bag includes at least one of Spandex and nylon.

20. A system as claimed in claim 12, wherein:
the flexible bag is further configured to maintain a negative mold of the portion of the object when the portion of the object is removed from proximity of the flexible bag and the vacuum suction is continued.
